(19) United States
(12) Patent Application Publication
(10) Pub. No.: US 2016/0019507 A1
(43) Pub. Date: Jan. 21, 2016

(54) Transaction Support Device, Transaction Support System, Transaction Support Method, and Program

(71) Applicant: Hitachi Systems, Ltd., Shinagawa-ku, Tokyo (JP)

(72) Inventors: Hiroki TAKAMURA, Kawasaki-shi, Kanagawa (JP); Michihiro OTA, Kita-ku, Tokyo (JP)

(73) Assignee: Hitachi Systems, Ltd., Shinagawa-ku, Tokyo (JP)

(21) Appl. No.: 14/772,983

(22) PCT Filed: Oct. 17, 2013
(86) PCT No.: PCT/JP2013/078174

§ 371 Date: Sep. 4, 2015

(30) Foreign Application Priority Data
Mar. 6, 2013 (JP) 2013-044216

(51) Int. Cl. G06Q 20/10; G06Q 10/08

(52) U.S. Cl. CPC G06Q 20/10; G06Q 10/083

(57) ABSTRACT

According to an embodiment, business processing related to commercial transactions is uniformly supported between a plurality of business entities such as retailers, wholesalers, and manufacturers. A transaction support device generates order information, shipping information, and receiving information, generates profit information indicating a profit of a first business entity based on cash information of the first business entity and the receiving information, generates profit information indicating a profit of a second business entity based on the shipping information of the second business entity, and outputs settlement information containing the profit information to a device of a finance company which acquires the cash sales recovered from the first business entity with respect to a transaction between the first business entity and the second business entity which is an order destination of the first business entity.

### TECHNICAL FIELD

The present invention relates to a transaction support device, a transaction support system, a transaction support method, and a program. This application claims the benefit of priority to Japanese Patent Application No. 2013-44216, filed on Mar. 6, 2013, the entire contents of which are incorporated herein by reference, for the specified designated countries where recognizing incorporation by reference of documents by reference is approved.

### BACKGROUND ART

In a commercial transaction according to the related art, for example, in a case where retailers, wholesalers, and manufacturers are business entities (transaction entities), business processings such as an order of a product, receiving of the order, shipping, arriving, invoicing, and payment are performed between the retailers and the wholesalers and between the wholesalers and the manufacturers. Each business entity has a computer system used in the transaction, and the computer system is designed and operated under a transaction procedure and a data format determined with respect to a client business entity. For example, Patent Literature 1 discloses a technology in which credits and debts between creditors and debtors are managed at a center in order to efficiently manage the credits and settlement of the debts.

### CITATION LIST

### Patent Literature

### Patent Literature 1: JP 2001-331759 A

### SUMMARY OF INVENTION

### Technical Problem

The business processing related to commercial transactions is performed in a wide variety. Besides the above-mentioned processings, for example, there are management of credit sales and credit purchases, management of sales, management of inventories, management of cash, and the like. Each business entity needs to perform these business processings. However, these business processings cause high cost and much trouble.

It is an object of the present invention to uniquely support the business processings related to the commercial transactions between a plurality of business entities such as the retailers, the wholesales, and manufacturers.

### Solution to Problem

The present application includes a plurality of units for solving at least a part of the above problems, and the following configurations can be exemplified.

According to a first aspect of the present invention to solve at least a part of the above problems, there is provided a transaction support device that supports a transaction between a plurality of business entities in a business relation through a network. The transaction support device includes: a sales information acquisition unit configured to acquire sales information of a first business entity through the network; a transaction processing unit configured to perform generating of order information of the first business entity based on the acquired sales information, generating of shipping information of a second business entity based on the order information, and generating of receiving information of the first business entity based on the shipping information with respect to a transaction between the first business entity and the second business entity which is an order destination of the first business entity; a cash information acquisition unit configured to acquire cash information indicating a cash sales recovered from the first business entity by a cash recovery company through the network from a device of the cash recovery company; a settlement processing unit configured to perform a first settlement processing in which account-receivable information indicating accounts receivable of the first business entity is generated based on the acquired cash information, account-payable information indicating accounts payable of the first business entity is generated based on the receiving information of the first business entity, and profit information indicating a profit of the first business entity is generated based on the account-receivable information and the account-payable information of the first business entity, and a second settlement processing in which account-receivable information indicating accounts receivable of the second business entity is generated based on the shipping information of the second business entity, and profit information indicating a profit of the second business entity is generated based on the account-receivable information of the second business entity; and a settlement information output unit configured to output settlement information containing the generated profit information of the first business entity and the second business entity to a device of a finance company through the network, the finance company acquiring the cash sales recovered from the first business entity from the cash recovery company.

The transaction processing unit may perform generating of order information of the second business entity based on the order information of the first business entity, generating of shipping information of a third business entity based on the order information, and generating of receiving information of the second business entity based on the shipping information with respect to a transaction between the second business entity and the third business entity which is an order destination of the second business entity. The settlement processing unit may generate account-payable information indicating accounts payable of the second business entity based on the receiving information of the second business entity, generate the profit information of the second business entity based on the account-receivable information and the account-payable information of the second business entity in the second settlement processing, and performs a third settlement processing in which account-receivable information indicating accounts receivable of the third business entity is generated based on the shipping information of the third business entity, and profit information indicating a profit of the third business entity is generated based on the account-receivable information of the third business entity. The settlement information output unit may output settlement information containing the generated profit information of the first business entity, the second business entity, and the third business entity to the device of the finance company.

The settlement processing unit may perform generating of commission information indicating commissions of the cash recovery company, the finance company, and a transaction support company which manages the transaction support device based on a predetermined calculation formula or a predetermined value. The settlement information output unit may output the settlement information containing the generated profit information of each business entity and the generated commission information of each company to the device of the finance company.

The transaction processing unit may acquire inventory information of the second business entity, determine whether the inventory information satisfies a predetermined condition on the order information based on the order information of the first business entity and the inventory information of the second business entity, and perform a transaction between the second business entity and the third business entity in a case where the predetermined condition is not satisfied.

According to a second aspect of the present invention to solve at least a part of the above problems, there is provided a program for causing a computer as a transaction support device that supports a transaction between a plurality of business entities in a business relation through a network. The program causes the computer to function as: a sales information acquisition unit configured to acquire sales information of a first business entity through the network; a transaction processing unit configured to perform generating of order information of the first business entity based on the acquired sales information, generating of shipping information of a second business entity based on the order information, and generating of receiving information of the first business entity based on the shipping information with respect to a transaction between the first business entity and the second business entity which is an order destination of the first business entity; a cash information acquisition unit configured to acquire cash information indicating a cash sales recovered from the first business entity by a cash recovery company through the network from a device of the cash recovery company; a settlement processing unit configured to perform a first settlement processing in which account-receivable information indicating accounts receivable of the first business entity is generated based on the acquired cash information, account-payable information indicating accounts payable of the first business entity is generated based on the receiving information of the first business entity, and profit information indicating a profit of the first business entity is generated based on the account-receivable information and the account-payable information of the first business entity, and a second settlement processing in which account-receivable information indicating accounts receivable of the second business entity is generated based on the shipping information of the second business entity, and profit information indicating a profit of the second business entity is generated based on the account-receivable information of the second business entity; and a settlement information output unit configured to output settlement information containing the generated profit information of the first business entity and the second business entity to a device of a finance company through the network, the finance company acquiring the cash sales recovered from the first business entity from the cash recovery company.

According to a third aspect of the present invention to solve at least a part of the above problems, there is provided a transaction support method in a transaction support device that supports a transaction between a plurality of business entities in a business relation through a network. The transaction support method includes: acquiring sales information of a first business entity through the network; generating order information of the first business entity based on the acquired sales information; generating shipping information of a second business entity based on the order information, and generating receiving information of the first business entity based on the shipping information with respect to a transaction between the first business entity and the second business entity which is an order destination of the first business entity; acquiring cash information indicating a cash sales recovered from the first business entity by a cash recovery company through the network from a device of the cash recovery company; performing a first settlement processing in which account-receivable information indicating accounts receivable of the first business entity is generated based on the acquired cash information, account-payable information indicating accounts payable of the first business entity is generated based on the receiving information of the first business entity, and profit information indicating a profit of the first business entity is generated based on the account-receivable information and the account-payable information of the first business entity, and a second settlement processing in which account-receivable information indicating accounts receivable of the second business entity is generated based on the shipping information of the second business entity, and profit information indicating a profit of the second business entity is generated based on the account-receivable information of the second business entity; and outputting settlement information containing the generated profit information of the first business entity and the second business entity to a device of a finance company through the network, the finance company acquiring the cash sales recovered from the first business entity from the cash recovery company.

According to a fourth aspect of the present invention to solve at least a part of the above problems, there is provided a transaction support system including: a transaction support device configured to support a transaction of a plurality of business entities in a business relation through a network; and a device of a finance company which is connected to the transaction support device through the network. The transaction support device includes a sales information acquisition unit configured to acquire sales information of a first business entity through the network, a transaction processing unit configured to perform generating of order information of the first business entity based on the acquired sales information, generating of shipping information of a second business entity based on the order information, and generating of receiving information of the first business entity based on the shipping information with respect to a transaction between the first business entity and the second business entity which is an order destination of the first business entity, a cash information acquisition unit configured to acquire cash information indicating a cash sales recovered from the first business entity by a cash recovery company through the network from a device of the cash recovery company, a settlement processing unit configured to perform a first settlement processing in which account-receivable information indicating accounts receivable of the first business entity is generated based on the acquired cash information, account-payable information indicating accounts payable of the first business entity is generated based on the receiving information of the first business entity, and profit information indicating a profit of the first business entity is generated based on the account-receivable information and the account-payable information of the first business entity, and a second settlement processing in which account-receivable information indicating accounts receivable of the second business entity is generated based on the shipping information of the second business entity, and profit information indicating a profit of the second business entity is generated based on the account-receivable information of the second business entity, and a settlement information output unit configured to output settlement information containing the generated profit information of the first business entity and the second business entity to the device of the finance company through the network. The device of the finance company includes a settlement information receiving unit configured to receive the settlement information from the transaction support device through the network, and a profit sharing unit configured to deposit a profit of the first business entity and a profit of the second business entity in an account of each business entity, based on the received settlement information, from the cash sales which is recovered by the cash recovery company from the first business entity and acquired by the finance company from the cash recovery company.

According to a fifth aspect of the present invention to solve at least a part of the above problems, there is provided a transaction support method in a transaction support system that includes a transaction support device configured to support a transaction of a plurality of business entities in a business relation through a network, and a device of a finance company which is connected to the transaction support device through the network. The transaction support method includes: acquiring, by the transaction support device, sales information of a first business entity through the network; generating, by the transaction support device, order information of the first business entity based on the acquired sales information, generating shipping information of a second business entity based on the order information, and generating receiving information of the first business entity based on the shipping information with respect to a transaction between the first business entity and the second business entity which is an order destination of the first business entity; acquiring, by the transaction support device, cash information indicating a cash sales recovered from the first business entity by a cash recovery company through the network from a device of the cash recovery company; performing, by the transaction support device, a first settlement processing in which account-receivable information indicating accounts receivable of the first business entity is generated based on the acquired cash information, account-payable information indicating accounts payable of the first business entity is generated based on the receiving information of the first business entity, and profit information indicating a profit of the first business entity is generated based on the account-receivable information and the account-payable information of the first business entity, and a second settlement processing in which account-receivable information indicating accounts receivable of the second business entity is generated based on the shipping information of the second business entity, and profit information indicating a profit of the second business entity is generated based on the account-receivable information of the second business entity; outputting, by the transaction support device, settlement information containing the generated profit information of the first business entity and the second business entity to the device of the finance company through the network; receiving, by the device of the finance company, the settlement information from the transaction support device through the network; and depositing, by the device of the finance company, a profit of the first business entity and a profit of the second business entity in an account of each business entity, based on the received settlement information, from the cash sales which is recovered by the cash recovery company from the first business entity and acquired by the finance company from the cash recovery company.

### Advantageous Effects of Invention

According to the present invention, it is possible to uniformly support business processing related to commercial transactions between a plurality of business entities such as retailers, wholesalers, and manufacturers.

Problems, configurations, and effects other than the above description will be apparent through the following explanation on embodiments.

### BRIEF DESCRIPTION OF DRAWINGS

FIG. 1 is a diagram illustrating an example of a schematic configuration of a transaction system 10 according to an embodiment of the present invention.

FIG. 2 is a diagram for describing the outline of processing (order to receiving) of the transaction system 10.

FIG. 3 is a diagram for describing the outline of processing (cash settlement) of the transaction system 10.

FIG. 4 is a diagram for describing the outline of cash flow which is realized by the transaction system 10.

FIG. 5 is a diagram illustrating an example of a functional configuration of a transaction support device 1.

FIG. 6 is a diagram illustrating an example of a configuration of a sales information DB 111.

FIG. 7 is a diagram illustrating an example of a configuration of an order information DB 112.

FIG. 8 is a diagram illustrating an example of a configuration of a shipping information DB 113.

FIG. 9 is a diagram illustrating an example of a configuration of a receiving information DB 114.

FIG. 10 is a diagram illustrating an example of a configuration of a product information DB 115.

FIG. 11 is a diagram illustrating an example of a configuration of an inventory information DB 116.

FIG. 12 is a diagram illustrating an example of a configuration of a cash information DB 117.

FIG. 13 is a diagram illustrating an example of a configuration of a settlement information DB 118.

FIG. 14 is a diagram illustrating an example of a configuration of a commission information DB 119.

FIG. 15 is a diagram illustrating an example of a schematic configuration of a computer 40.

FIG. 16 is a flowchart illustrating an example of an order processing (order to shipping instruction).

FIG. 17 is a flowchart illustrating an example of the order processing (inspection to receiving).

FIG. 18 is a flowchart illustrating an example of cash settlement processing.

FIG. 19 is a diagram for describing a relation between accounts receivable, accounts payable, and profits.

### DESCRIPTION OF EMBODIMENTS

Hereinafter, an embodiment of the present invention will be described with reference to the drawings.

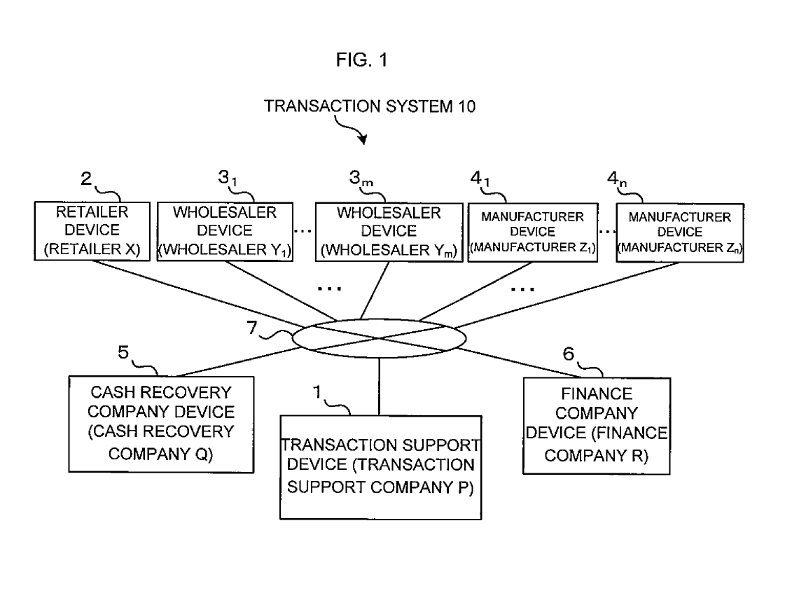

FIG. 1 is a diagram illustrating an example of a schematic configuration of a transaction system 10 according to an embodiment of the present invention.

In this embodiment, the description will be made focusing on commercial transactions between a retailer X, wholesalers Y₁ to Yₘ, and manufacturers Z₁ to Zₙ. The retailer X does business with one or more wholesalers Y from among the wholesalers Y₁ to Yₘ. The wholesalers Y₁ to Yₘ each do business with one or more manufacturers Z from among the manufacturers Z₁ to Zₙ.

The transaction system 10 includes a transaction support device 1 which is a business system of a transaction support company P, a retailer device 2 which is a business system of the retailer X, wholesaler devices 3₁ to 3ₘ which are business systems of the wholesalers Y₁ to Yₘ, manufacturer devices 4₁ to 4ₙ which are business systems of the manufacturers Z₁ to Zₙ, a cash recovery company device 5 which is a business system of a cash recovery company Q, and a finance company device 6 which is a business system of a finance company R. The respective devices can transmit and receive information through a network 7.

As to be described in detail, the transaction support device 1 is a device which uniformly controls business processing such as an order processing and a settlement processing between the retailer X, the wholesalers Y₁ to Yₘ, and the manufacturers Z₁ to Zₙ so as to support the commercial transactions between the retailer X, the wholesalers Y₁ to Yₘ, and the manufacturers Z₁ to Zₙ.

The retailer device 2, for example, acquires sales information from an existing POS (Point Of Sale) system or the like and transmits the sales information to the transaction support device 1. In addition, the retailer device 2, for example, acquires various types of information such as order information, shipping information, receiving information, and settlement information managed by the transaction support device 1 from the transaction support device 1, and displays the information or prints the information by a printing device.

The wholesaler device 3, for example, acquires various types of information such as the order information, the shipping information, the receiving information, and the settlement information managed by the transaction support device 1 from the transaction support device 1, and displays the information or prints the information by the printing device.

The manufacturer device 4, for example, acquires various types of information such as the order information, the shipping information, the receiving information, and the settlement information managed by the transaction support device 1 from the transaction support device 1, and displays the information or prints the information by the printing device.

The cash recovery company device 5, for example, acquires information on the cash sales collected from the retailer X from a money depositing machine or the like, and transmits the information to the transaction support device 1.

Further, the cash recovery company Q, for example, recovers the sales cash in a predetermined period from a store of the retailer X or the like, and once deposits money in the money depositing machine or the like. Then, the money is deposited in a predetermined account managed by the finance company R.

The finance company device 6, for example, acquires the settlement information on the profits of the retailer X, the wholesalers Y₁ to Yₘ, the manufacturers Z₁ to Zₙ, and the like from the transaction support device 1. In addition, the finance company device 6 deposits the profits of the respective companies in the accounts of the respective companies from the sales cash deposited in the predetermined account of the retailer X based on the acquired settlement information (that is, the profits are shared).

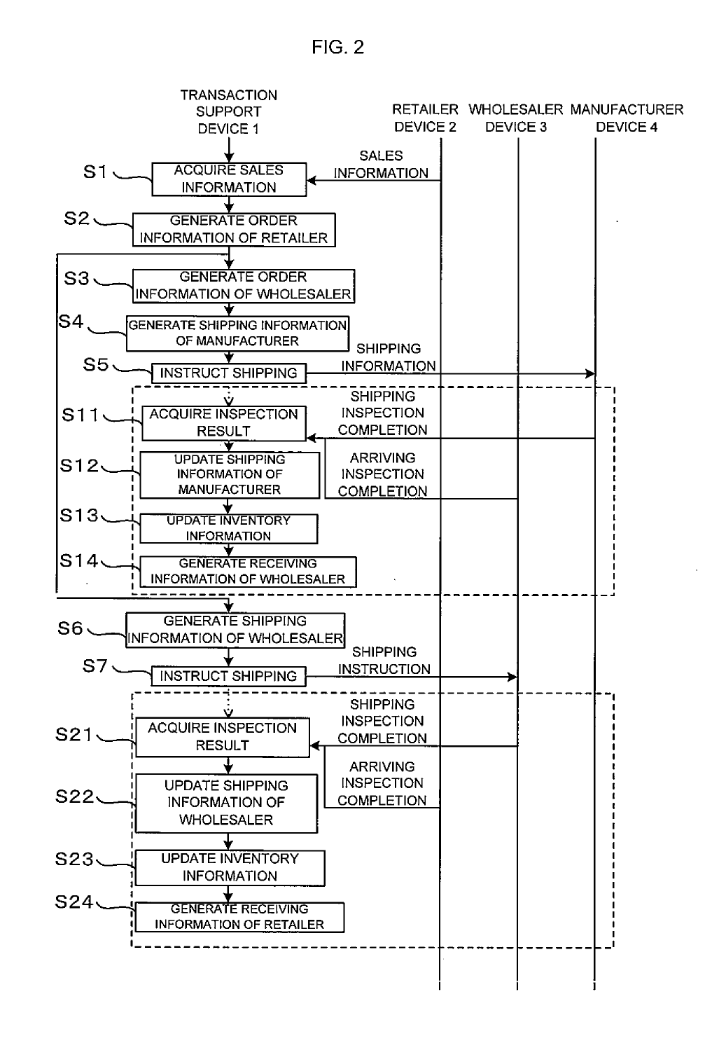

FIG. 2 is a diagram for describing the outline of the processing (order to receiving) of the transaction system 10.

In this embodiment, in order to explain clearly, it is assumed that the inventory of the retailer X is not insufficient with respect to the demand of the consumers. In addition, the inventory of the wholesalers Y₁ to Yₘ is assumed not to be insufficient with respect to the order of the retailer X. In addition, the inventory of the manufacturers Z₁ to Zₙ is assumed not to be insufficient with respect to the order of the wholesaler Y. In addition, the order of the retailer X is assumed that products sold to the consumers are supplemented to the inventory of the retailer X. In addition, the order of the wholesaler Y is assumed that products sold (shipped) to the retailer X are supplemented to the inventory of the wholesaler Y. In addition, it is assumed that the order from the manufacturer Z to another one is not considered.

First, the transaction support device 1 acquires the sales information in a predetermined period of the retailer X from the retailer device 2 (Step S1), and generates the order information of the retailer X with respect to the wholesaler Y based on the sales information (Step S2). Further, the transaction support device 1 may transmit the generated order information to at least one of the retailer device 2 and the wholesaler device 3.

Here, the transaction support device 1 determines whether the inventory of the wholesaler Y who ships an order quantity of ordered products is sufficient for a predetermined number. After Steps S3 to S5 described below are performed on the wholesaler Y whose inventory is insufficient for the predetermined number, Steps S6 to S7 described below are performed. Steps S3 to S5 described below are skipped for the wholesaler Y whose inventory is sufficient and Steps S6 to S7 described below are performed.

The transaction support device 1 generates the order information of the wholesaler Y with respect to the manufacturer Z based on the order information of the retailer X with respect to the wholesaler Y (Step S3). In addition, the transaction support device 1 generates the shipping information of the manufacturer Z based on the order information of the wholesaler Y with respect to the manufacturer Z (Step S4), and transmits a shipping instruction to the manufacturer device 4 (Step S5). Further, the transaction support device 1 may transmit the generated order information to at least one of the wholesaler device 3 and the manufacturer device 4. In addition, the generated shipping information may be transmitted to at least one of the wholesaler device 3 and the manufacturer device 4.

Further, a timing of the shipping instruction on the manufacturer Z is not limited to Step S5, and may be a timing of Steps S3 to S4, for example, as long as the manufacturer Z can recognize that the product is to be shipped.

The transaction support device 1 generates the shipping information of the wholesaler Y based on the order information of the retailer X with respect to the wholesaler Y (Step S6), and transmits the shipping instruction to the wholesaler device 3 (Step S7). Further, the transaction support device 1 may transmit the generated shipping information to at least one of the retailer device 2 and the wholesaler device 3.

Further, a timing of the shipping instruction on the wholesaler Y is not limited to Step S7, and may be a timing of Step S6, for example, as long as the wholesaler Y can recognize that the product is to be shipped.

The processes of Steps S11 to S14 are performed in a case where inspection results of the manufacturer Z and the wholesaler Y on a target product of the shipping instruction of Step S5 is acquired.

The transaction support device 1 acquires the inspection result (the completion of a shipping inspection of the manufacturer Z or the completion of an arriving inspection of the wholesaler Y) on the shipping information of the manufacturer Z (Step S11), and updates the inspection state of the shipping information of the subject manufacturer Z into “shipping inspection completion” or “arriving inspection completion” (Step S12). In addition, the transaction support device 1 updates inventory information of the manufacturer Z based on the shipping information of the manufacturer Z where the shipping inspection is completed, and updates inventory information of the wholesaler Y based on the shipping information of the manufacturer Z where the arriving inspection is completed (Step S13). In addition, the transaction support device 1 generates the receiving information of the wholesaler Y based on the shipping information of the manufacturer Z where the arriving inspection is completed (Step S14). Further, the transaction support device 1 may transmit the generated receiving information to at least one of the wholesaler device 3 and the manufacturer device 4.

The processes of Steps S21 to S24 are performed in a case where the inspection results of the wholesaler Y and the retailer X on the target product of the shipping instruction of Step S7 is acquired.

The transaction support device 1 acquires the inspection result (the completion of the shipping inspection of the wholesaler Y or the completion of the arriving inspection of the retailer X) on the shipping information of the wholesaler Y (Step S21), and updates the inspection state of the shipping information of the subject wholesaler Y into “shipping inspection completion” or “arriving inspection completion” (Step S22). In addition, the transaction support device 1 updates the inventory information of the wholesaler Y based on the shipping information of the wholesaler Y where the shipping inspection is completed, and updates the inventory information of the retailer X based on the shipping information of the wholesaler Y where the arriving inspection is completed (Step S23). In addition, the transaction support device 1 generates the receiving information of the retailer X based on the shipping information of the wholesaler Y where the arriving inspection is completed (Step S24). Further, the transaction support device 1 may transmit the generated receiving information to at least one of the retailer device 2 and the wholesaler device 3.

In this way, the business processing such as the order processing, the shipping processing, the inventory processing, and the receiving processing between the retailer X, the wholesaler Y, and the manufacturer Z is uniformly controlled by the transaction system 10.

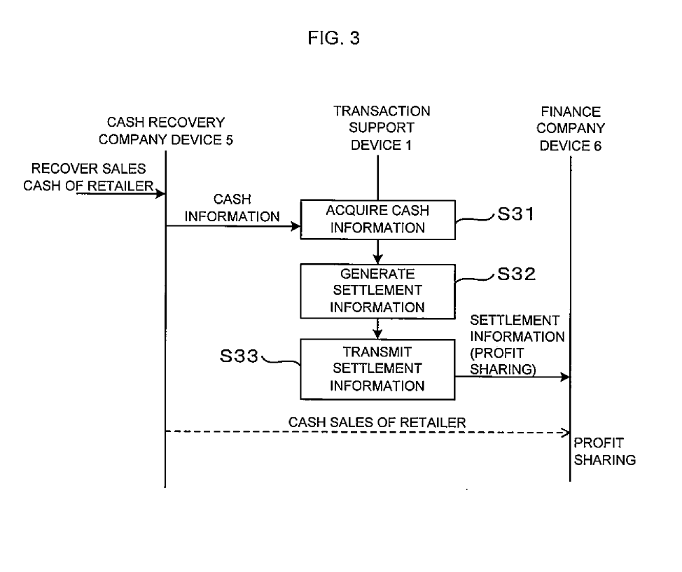

FIG. 3 is a diagram for describing the outline of the processing (cash settlement) of the transaction system 10.

The cash recovery company Q recovers the sales cash of the retailer X from the store or the like of the retailer X and deposits the sales cash in the money depositing machine or the like. The cash recovery company device 5 acquires cash information on the cash sales recovered from the retailer X through the money depositing machine or the like, or receives an input from an operator and stores the input. Thereafter, the cash recovery company Q deposits the sales cash of the received retailer X in the predetermined account managed by the finance company R.

The transaction support device 1 acquires the cash information on the cash sales of the retailer X of the predetermined period from the cash recovery company device 5, and generates the cash information of the retailer X based on the subject cash information (Step S31).

Then, the transaction support device 1 generates the settlement information indicating the profit sharing between the retailer X, the wholesaler Y, the manufacturer Z, the transaction support company P, the cash recovery company Q, and the finance company R with respect to the predetermined period similarly to the cash sales (Step S32). Step S32 will be described in detail below, and thus simply described herein.

The transaction support device 1 calculates the accounts receivable of the retailer X, the wholesaler Y, and the manufacturer Z. The accounts receivable of the retailer X is calculated based on the cash sales of the retailer X. In practice, the cash sales is once acquired by the retailer X, but as described below, the cash sales are used as the accounts receivable for convenience in order to share the cash sales to the respective companies. The accounts receivable of the wholesaler Y may be calculated based on the shipping information of the wholesaler Y. The accounts receivable of the manufacturer Z may be calculated based on the shipping information of the manufacturer Z.

In addition, the transaction support device 1 calculates the accounts payable of the retailer X, the wholesaler Y, and the manufacturer Z. The accounts payable of the retailer X can be calculated based on the receiving information of the retailer X. The accounts payable of the wholesaler Y can be calculated based on the receiving information of the wholesaler Y. Further, in this embodiment, since an order from the manufacturer Z to another one is not considered, the accounts payable of the manufacturer Z is assumed to 0.

In addition, the transaction support device 1 generates the settlement information indicating the profit sharing between the retailer X, the wholesaler Y, the manufacturer Z, the transaction support company P, the cash recovery company Q, and the finance company R based on the settlement information indicating the accounts payable and the accounts receivable of the retailer X, the wholesaler Y, and the manufacturer Z and commission information of the transaction support company P, the cash recovery company Q, and the finance company R calculated by a predetermined calculation method.

Further, the transaction support device may transmit the generated settlement information of the retailer X, the wholesaler Y, and the manufacturer Z to the retailer device 2, the wholesaler device 3, and the manufacturer device 4, respectively.

Then, the transaction support device 1 transmits the settlement information indicating the profit sharing of the respective companies in the predetermined period to the finance company device 6 (Step S33).

The finance company device 6 deposits the profits in the accounts of the retailer X, the wholesaler Y, the manufacturer Z, the transaction support company P, the cash recovery company Q, and the finance company R from the sales cash of the retailer X deposited in the predetermined account based on the settlement information indicating the profit sharing of the respective companies received from the transaction support device 1 (that is, the profits are shared).

In this way, the business processing such as the management of the accounts payable or the accounts receivable and the sharing of the profits between the retailer X, the wholesaler Y, and the manufacturer Z is uniformly controlled by the transaction system 10.

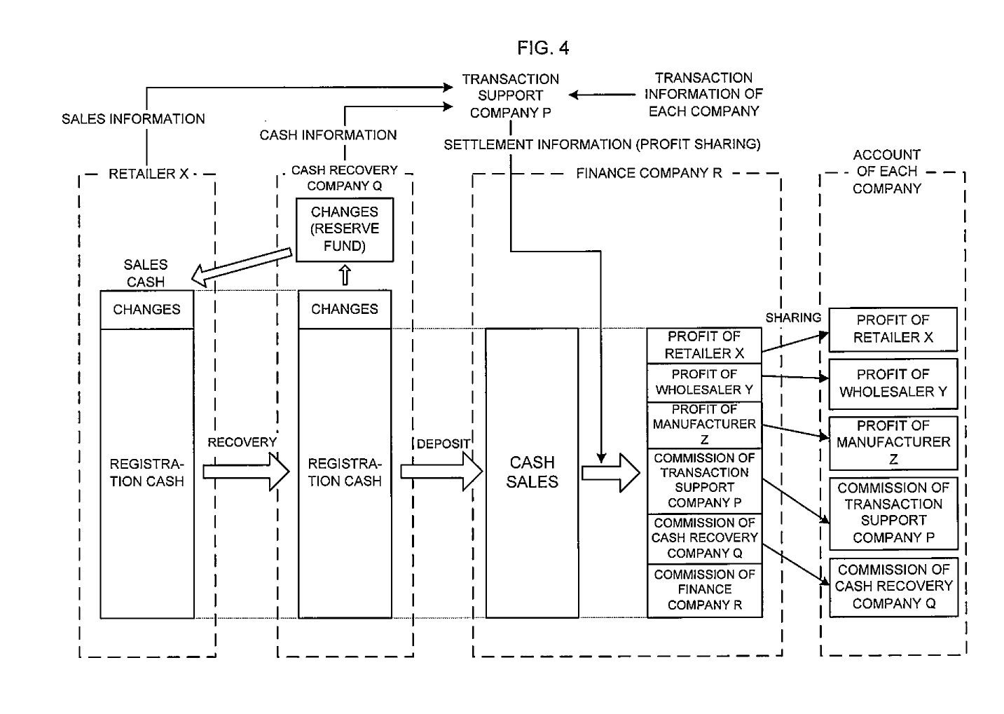

FIG. 4 is a diagram for describing the outline of a cash flow realized by the transaction system 10.

The sales cash (changes and registration cash) of the retailer X is recovered by the cash recovery company Q and is temporarily stored in the money depositing machine of the cash recovery company Q after the balancing of a change reserve fund. Thereafter, the cash recovery company Q deposits the received sales cash of the retailer X in the predetermined account managed by the finance company R.

As described above, the transaction support company P determines the profit sharing of the respective companies (the retailer X, the wholesaler Y, the manufacturer Z, the transaction support company P, the cash recovery company Q, and the finance company R) based on the sales information from the retailer X, the transaction information between the retailer X, the wholesaler Y, the manufacturer Z, and the like, and the cash information from the cash recovery company Q, and informs the profit sharing to the finance company R.

On the basis of the profit sharing of the respective companies informed from the transaction support company P, the finance company R shares the profit of each company (the retailer X, the wholesaler Y, the manufacturer Z, the transaction support company P, the cash recovery company Q, and the finance company R) from the deposited cash sales of the retailer X, and deposits the profit of each company in the account of each company managed by its own company or another company.

In this way, the profit of each company (the retailer X, the wholesaler Y, the manufacturer Z, the transaction support company P, the cash recovery company Q, and the finance company R) is shared by the transaction system 10 from the cash sales of the retailer X more speedily and more reliably.

Regarding the configuration of the transaction system 10 of FIG. 1, the main components have been described for the explanation of the present invention, but the present invention is not limited to the above configuration. In addition, the configuration provided with a typical transaction system is not excluded.

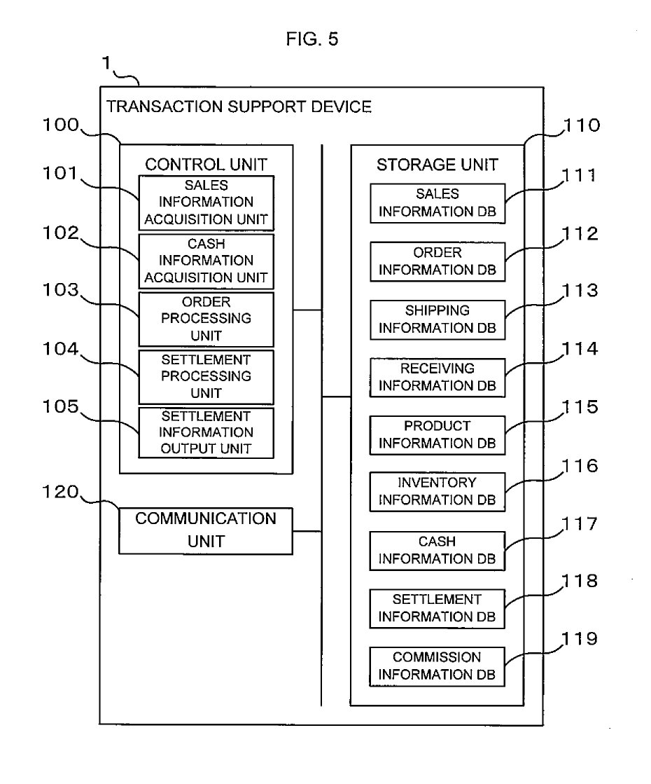

FIG. 5 is a diagram illustrating an example of a functional configuration of the transaction support device 1.

The transaction support device 1 includes a control unit 100, a storage unit 110, and a communication unit 120.

In the storage unit 110, information necessary for the control of the transaction support device 1 is stored. In the storage unit 110, a sales information DB (Data Base; hereinafter referred to as a “DB”) 111, an order information DB 112, a shipping information DB 113, a receiving information DB 114, a product information DB 115, an inventory information DB 116, a cash information DB 117, a settlement information DB 118, and a commission information DB 119 are stored.

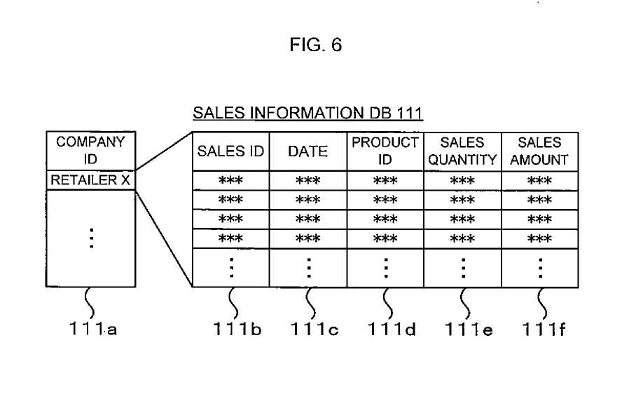

In the sales information DB 111, information specifying the cash sales of a product of each company is stored. FIG. 6 is a diagram illustrating an example of the configuration of the sales information DB 111. In the sales information DB 111, a sales record for specifying the cash sales of each date and product of the subject company is stored for each company ID 111a for identifying the company. The sales record includes a sales ID 111b for specifying the subject sales record, a date 111c indicating a sales date, a product ID 111d for specifying a sold product, a sales quantity 111e indicating the amount of sold products, and a sales amount 111f calculated from a unit price and the sales quantity of the sold products. In this embodiment, the sales information of the retailer X is stored in the sales information DB 111.

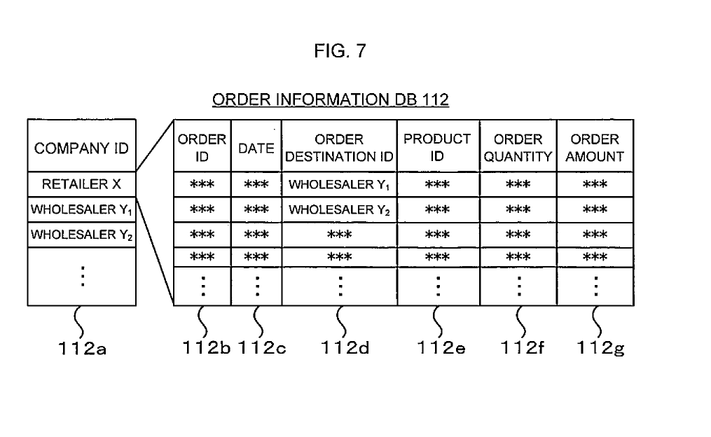

In the order information DB 112, information for specifying an order of a product of each company is stored. FIG. 7 is a diagram for describing an example of a configuration of the order information DB 112. In the order information DB 112, an order record for specifying the order of the product of the subject company is stored for each company ID 112a with which the company of an order source is specified. The order record includes an order ID 112b for specifying the subject order record, a date 112c indicating an order date, an order destination ID 112d for specifying a company of an order destination, a product ID 112e for specifying an ordered product, an order quantity 112f indicating the quantity of ordered products, and an order amount 112g which is calculated from the unit price and the order quantity of the ordered products. In this embodiment, in the order information DB 112, the order information of the retailer X and the wholesalers Y₁ to Yₘ is stored.

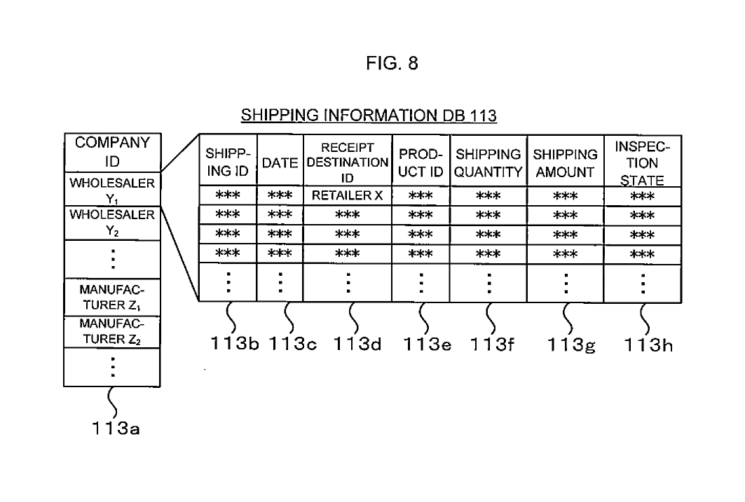

In the shipping information DB 113, the information for specifying the shipping the product of each company is stored. FIG. 8 is a diagram illustrating an example of a configuration of the shipping information DB 113. In the shipping information DB 113, a shipping record for specifying the shipping of the product of the subject company is stored for each company ID 113a for specifying a company of a shipping source. The shipping record includes a shipping ID 113b for specifying the subject shipping record, a date 113c indicating a shipping date, a receipt destination ID 113d for specifying a company of a receipt destination, a product ID 113e for specifying the shipped product, a shipping quantity 113f indicating the quantity of the shipped product, a shipping amount 113g which is calculated from the unit price and the shipping quantity of the shipped product, and an inspection state 113h (“uninspected product”, “shipping inspection completion”, “arriving inspection completion”) of a shipping product indicated by the subject shipping record. In this embodiment, the shipping information of the wholesalers Y₁ to Yₘ and the manufacturers Z₁ to Zₙ is stored in the shipping information DB 113.

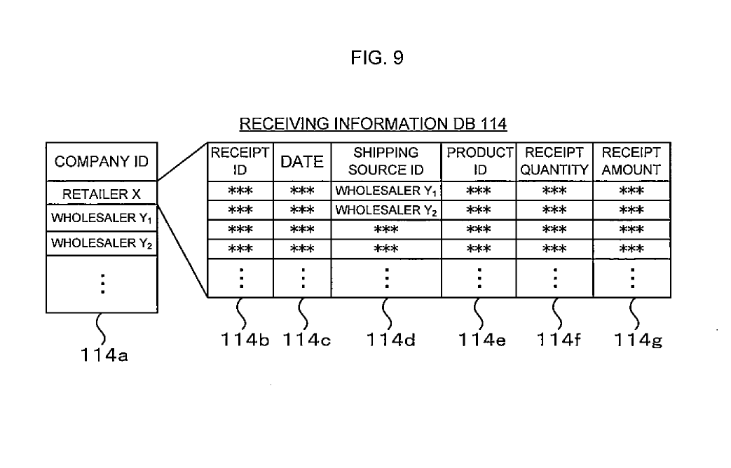

In the receiving information DB 114, information for specifying the receipt of the product of each company is stored. FIG. 9 is a diagram illustrating an example of a configuration of the receiving information DB 114. In the receiving information DB 114, a receipt record for specifying the receipt of the product of the subject company is stored for each company ID 114a for specifying a company of a receipt source. The receipt record includes a receipt ID 114b for specifying the subject receipt record, a date 114c indicating a receipt date, a shipping source ID 114d for specifying a company of the shipping source, a product ID 114e for specifying the received product, a receipt quantity 114f indicating the quantity of the received products, and a receipt amount 114g which is calculated from the unit price and the receipt quantity of the received product. In this embodiment, the receiving information of the retailer X and the wholesalers Y₁ to Yₘ is stored in the receiving information DB 114.

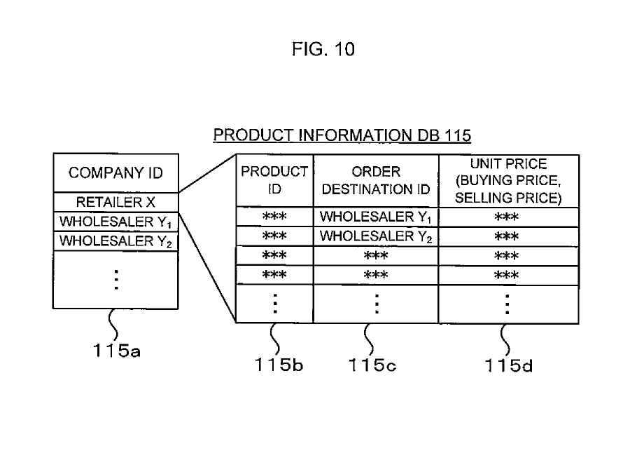

In the product information DB 115, information for specifying the order destination of the product of each company is stored. FIG. 10 is a diagram illustrating an example of a configuration of the product information DB 115. In the product information DB 115, a product record for specifying the order destination for each product of the subject company is stored for each company ID 115a for specifying a company of the order source. The product record includes a product ID 115b for specifying the product, an order destination ID 115c for specifying a company of the subject order destination of the product, and a unit price 115d indicating a selling price and a buying price of the subject product. In this embodiment, the product information of the retailer X and the wholesalers Y₁ to Yₘ is stored in the product information DB 115.

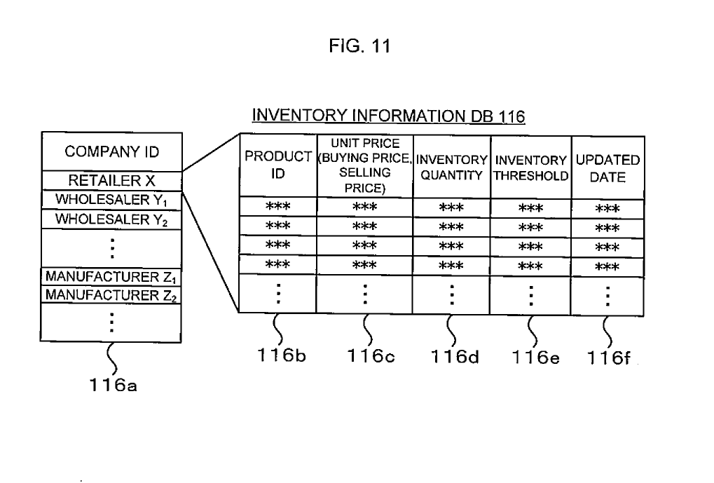

In the inventory information DB 116, information for managing the inventory of the products of each company is stored. FIG. 11 is a diagram illustrating an example of a configuration of the inventory information DB 116. In the inventory information DB 116, an inventory record of each product of the subject company is stored for each company ID 116a for specifying a company. The inventory record includes a product ID 116b for specifying a product, a unit price 116c indicating the selling price and the buying price of the subject product, an inventory quantity 116d indicating the stocked quantity of the subject products, an inventory threshold 116e which is a reference to determine whether the subject product is ordered, and an updated date 116f indicating a date when the inventory quantity is updated. In this embodiment, the inventory information of the retailer X, the wholesalers Y₁ to Yₘ, and the manufacturers Z₁ to Zₙ is stored in the inventory information DB 116.

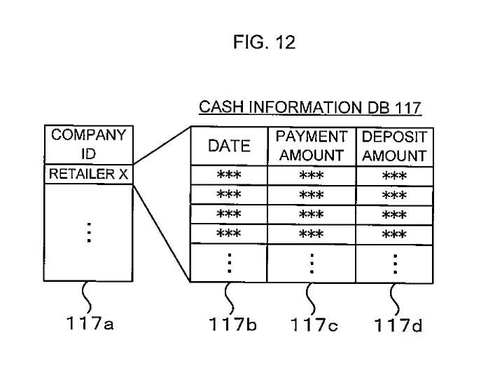

In the cash information DB 117, information on the cash sales recovered from each company is stored. FIG. 12 is a diagram illustrating an example of a configuration of the cash information DB 117. In the cash information DB 117, a cash record of each day of the subject company is stored for each company ID 117a for specifying the company. The cash record includes a date 117b indicating a date when the recovered cash sales is summed up, a payment amount 117c from the subject company, and a deposit amount 117d such as the change reserve fund which is deducted from the payment amount and returned to the subject company. In this embodiment, the cash information of the retailer X is stored in the cash information DB 117.

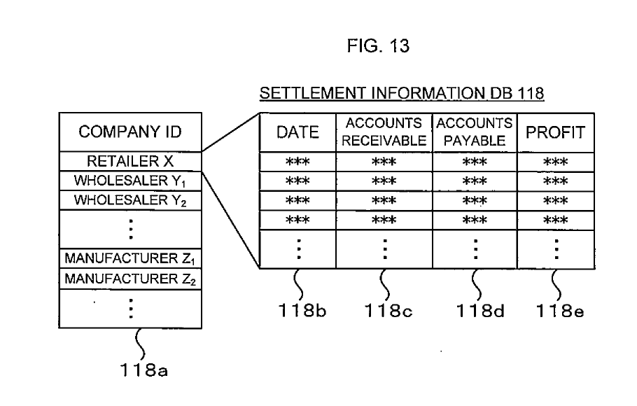

In the settlement information DB 118, information for specifying the profit of each company is stored. FIG. 13 is a diagram illustrating an example of a configuration of the settlement information DB 118. In the settlement information DB 118, a settlement record for each day of the subject company is stored for each company ID 118a for specifying the company. The settlement record includes a date 118b indicating a date when the accounts receivable, the accounts payable, and the profit are added up, accounts receivable 118c, accounts payable 118d, and a profit 118e which is a difference between the accounts receivable and the accounts payable. In this embodiment, the settlement information of the retailer X, the wholesalers Y₁ to Yₘ, and the manufacturers Z₁ to Zₙ is stored in the settlement information DB 118.

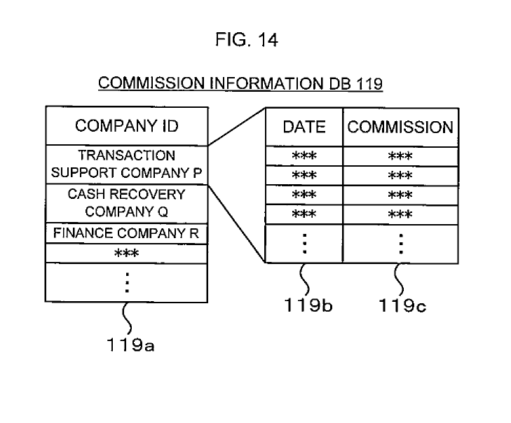

In the commission information DB 119, information for specifying a commission of each company is stored. FIG. 14 is a diagram illustrating an example of a configuration of the commission information DB 119. In the commission information DB 119, a commission record for each day of the subject company is stored for each company ID 119a for specifying the company. The commission record includes a date 119b indicating a day when the commission is summed up and a commission 119c. In this embodiment, the commission information of the transaction support company P, the cash recovery company Q, and the finance company R is stored in the commission information DB 119.

Returning to FIG. 5, the description will be continued. The control unit 100 controls the entire portion of the transaction support device 1. The control unit 100 includes a sales information acquisition unit 101, a cash information acquisition unit 102, an order processing unit (also referred to as a transaction processing unit) 103, a settlement processing unit 104, and a settlement information output unit 105.

The sales information acquisition unit 101 makes a communication with the retailer device 2 through the communication unit 120, acquires the sales information of the retailer X from the retailer device 2, and stores the acquired sales information in the sales information DB 111. In this embodiment, for example, the sales quantity and the sales amount of each product for each day are included in the sales information.

The cash information acquisition unit 102 makes a communication with the cash recovery company device 5 through the communication unit 120, acquires the cash information of the retailer X from the cash recovery company device 5, and stores the acquired cash information in the cash information DB 117. In this embodiment, for example, the payment amount and the deposit amount for each day are included in the cash information.

The order processing unit 103 generates the order information of the retailer X based on the sales information of the retailer X, and stores the generated order information in the order information DB 112. In addition, the order processing unit 103 determines whether the inventory of the wholesaler Y in a case where the order quantity of products are shipped is sufficient for a predetermined quantity based on the order information of the retailer X and the inventory information of the wholesaler Y.

In a case where the inventory of the wholesaler Y is insufficient for the predetermined quantity, the order processing unit 103 generates the order information of the wholesaler Y based on the order information of the retailer X, and stores the generated order information in the order information DB 112. In addition, the order processing unit 103 generates the shipping information of the manufacturer Z based on the order information of the wholesaler Y, and stores the generated shipping information in the shipping information DB 113. In addition, the order processing unit 103 sends the shipping information of the manufacturer Z as the shipping instruction to the manufacturer device 4 through the communication unit 120.

In a case where the inventory of the wholesaler Y is insufficient for the predetermined quantity, or a case where the inventory of the wholesaler Y is sufficient for the predetermined quantity, the order processing unit 103 generates the shipping information of the wholesaler Y based on the order information of the retailer X, and stores the generated shipping information in the shipping information DB 113. In addition, the order processing unit 103 sends the shipping information of the wholesaler Y as the shipping instruction to the wholesaler device 3 through the communication unit 120.

In addition, the order processing unit 103 makes a communication with the manufacturer device 4 and the wholesaler device 3 through the communication unit 120, and acquires the inspection results (the completion of the shipping inspection of the manufacturer Z and the completion of the arriving inspection of the wholesaler Y) on the shipping information of the manufacturer Z from the manufacturer device 4 and the wholesaler device 3. The order processing unit 103 updates the inspection state of the shipping information of the manufacturer Z stored in the shipping information DB 113 based on the acquired inspection results. In addition, the order processing unit 103 updates the inventory information of the manufacturer Z stored in the inventory information DB 116 based on the shipping information of the manufacturer Z where the shipping inspection is completed. In addition, the order processing unit 103 updates the inventory information of the wholesaler Y stored in the inventory information DB 116 based on the shipping information of the manufacturer Z where the arriving inspection is completed. In addition, the order processing unit 103 generates the receiving information of the wholesaler Y based on the shipping information of the manufacturer Z where the arriving inspection is completed, and stores the generated receiving information in the receiving information DB 114.

In addition, the order processing unit 103 makes a communication with the wholesaler device 3 and the retailer device 2 through the communication unit 120, and acquires the inspection results (the completion of the shipping inspection of the wholesaler Y and the completion of the arriving inspection of the retailer X) on the shipping information of the wholesaler Y from the wholesaler device 3 and the retailer device 2. The order processing unit 103 updates the inspection state of the shipping information of the wholesaler Y stored in the shipping information DB 113 based on the acquired inspection results. In addition, the order processing unit 103 updates the inventory information of the wholesaler Y stored in the inventory information DB 116 based on the shipping information of the wholesaler Y where the shipping inspection is completed. In addition, the order processing unit 103 updates the inventory information of the retailer X stored in the inventory information DB 116 based on the shipping information of the wholesaler Y where the arriving inspection is completed. In addition, the order processing unit 103 generates the receiving information of the retailer X based on the shipping information of the wholesaler Y where the arriving inspection is completed, and stores the acquired receiving information in the receiving information DB 114.

The settlement processing unit 104 calculates the accounts receivable of the retailer X based on the cash information of the retailer X, and stores the calculated accounts receivable in the settlement information DB 118. In addition, the settlement processing unit 104 calculates the accounts receivable of the wholesaler Y based on the shipping information of the wholesaler Y, and stores the calculated accounts receivable in the settlement information DB 118. In addition, the settlement processing unit 104 calculates the accounts receivable of the manufacturer Z based on the shipping information of the manufacturer Z, and stores the calculated accounts receivable in the settlement information DB 118.

In addition, the settlement processing unit 104 calculates the accounts payable of the retailer X based on the receiving information of the retailer X, and stores the calculated accounts payable in the settlement information DB 118. In addition, the settlement processing unit 104 calculates the accounts payable of the wholesaler Y based on the receiving information of the wholesaler Y, and stores the calculated accounts payable in the settlement information DB 118. Further, in this embodiment, since an order from the manufacturer Z to another one is not considered, the accounts payable of the manufacturer Z is assumed to 0.

In addition, the settlement processing unit 104 calculates the commissions of the transaction support company P, the cash recovery company Q, and the finance company R based on a predetermined calculation formula of the commission, and stores the calculated commissions in the commission information DB 119.

In addition, the settlement processing unit 104 calculates the profit of the retailer X based on the accounts receivable and the accounts payable of the retailer X and the commissions of the transaction support company P, the cash recovery company Q, and the finance company R, and stores the calculated profit in the settlement information DB 118. In addition, the settlement processing unit 104 calculates the profit of the wholesaler Y based on the accounts receivable and the accounts payable of the wholesaler Y, and stores the calculated profit in the settlement information DB 118. In addition, the settlement processing unit 104 calculates the profit of the manufacturer Z based on the accounts receivable and the accounts payable of the manufacturer Z, and stores the calculated profit in the settlement information DB 118.

The settlement information output unit 105 sends the settlement information containing the profit of each company (the retailer X, the wholesaler Y, and the manufacturer Z) stored in the settlement information DB 118 and the commission of each company (the transaction support company P, the cash recovery company Q, and the finance company R) stored in the commission information DB 119 to the finance company device 65 through the communication unit 120.

The communication unit 120 transmits or receives the information through the network 7.

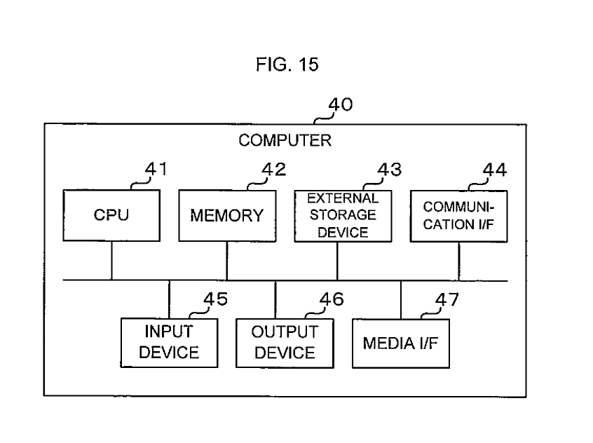

For example, as illustrated in FIG. 15 (a diagram illustrating an example of a schematic configuration of a computer 40), the above-mentioned transaction support device 1 can be realized by a computer 40 which includes a CPU (Central Processing Unit) 41, a memory 42, an external storage device 43 such as a HDD, a communication interface (I/F) 44 for the connection to a wired or wireless communication network, an input device 45 such as a mouse or a keyboard, an output device 46 such as a liquid crystal display, and a media I/F 47 which writes or reads information with respect to a recording medium such as a DVD (Digital Versatile Disk).

For example, the control unit 100 can be realized such that a predetermined program stored in the external storage device 43 is loaded into the memory 42 and executed by the CPU 41. The storage unit 110 can be realized such that the CPU 41 uses the memory 42 or the external storage device 43. The communication unit 120 can be realized such that the CPU 41 uses the communication I/F 44. Further, the storage unit 110 may be provided on the outside of the transaction support device 1, and the control unit 100 may transmit or receive the information with respect to the storage unit 110 through the communication unit 120.

The predetermined program described above may be downloaded from the network into the external storage device 43 through the communication I/F 44, and then loaded onto the memory 42 and executed by the CPU 41. In addition, the program may be directly loaded onto the memory 42 from the network through the communication I/F 44, and executed by the CPU 41. In addition, the computer 40 may load the predetermined program from the recording medium set in the media I/F 47 to the external storage device 43 or the memory 42.

Further, for example, the retailer device 2, the wholesaler device 3, the manufacturer device 4, the cash recovery company device 5, and the finance company device 6 may also be realized by the computer 40 as illustrated in FIG. 15.

The functional configuration of the transaction support device 1 of FIG. 5 is classified according to the content of main processings in order to help with understanding. The present invention is not limited to a method of classifying the components or the names thereof. The configuration of the transaction support device 1 may be classified into more components according to the processing content. In addition, one component may be classified into many parts to perform more processings. In addition, the processing of each component may be executed by one hardware unit, or may be executed by a plurality of hardware units. In addition, the processing of each component may be realized by one program, or may be realized by a plurality of programs. In addition, for example, the storage unit 110 may be established on a storage device connected to the transaction support device 1 through the network or the like. In addition, the configuration of each database of FIGS. 6 to 14 is a mere example, and not limited to the data structure illustrated in the drawings.

Next, the processings performed in the transaction support device 1 will be described.

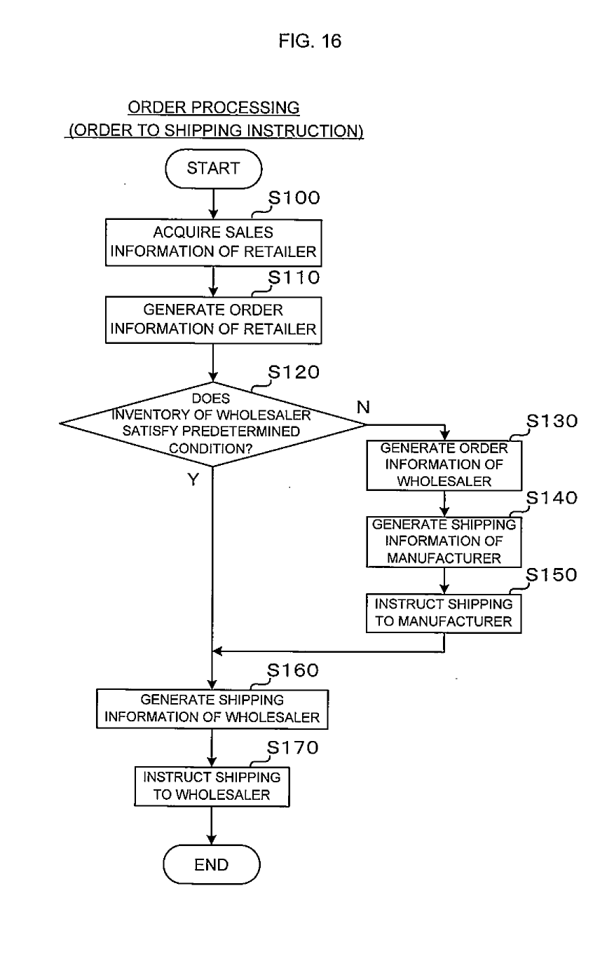

FIG. 16 is a flowchart illustrating an example of an order processing (order to shipping instruction). This flow, for example, starts in a predetermined period such as a day, a week, or a month. The predetermined period, for example, may be determined between the retailer X and the transaction support company P.

When this flow starts, the transaction support device 1 acquires the sales information of the retailer X (Step S100). Specifically, the sales information acquisition unit 101 makes a communication with the retailer device 2 through the communication unit 120, and acquires the sales information of the retailer X of the predetermined period. In addition, the sales information acquisition unit 101 generates the sales record for each date and product based on the sales information of the retailer X of the acquired predetermined period, and stores the generated sales record in the sales information DB 111 in association with the company ID 111a of the retailer X. The sales information acquisition unit 101 sets an ID for uniquely specifying the generated sales record in the sales ID 111b. In addition, the sales information acquisition unit 101 sets the date, the product ID, the sales quantity, and the sales amount contained in the acquired sales information of the retailer X to the date 111c, the product ID 111d, the sales quantity 111e, and the sales amount 111f, respectively.

Then, the transaction support device 1 generates the order information of the retailer X (Step S110). Specifically, the order processing unit 103 generates the corresponding order record for each sales record of the retailer X generated in Step S100, and stores the generated order record in the order information DB 112 in association with the company ID 112a of the retailer X.

The order processing unit 103 performs the following process for each generated order record. The order processing unit 103 sets an ID for uniquely specifying the generated order record to the order ID 112b. In addition, the order processing unit 103 sets the date 112c with the date when the order record is generated. In addition, the order processing unit 103 sets the order destination ID 112d with a company ID of a company (here, any one of the wholesalers Y₁ to Yₘ) of the order destination of the product which is indicated by the product ID 111d contained in the corresponding sales record. In other words, the order processing unit 103 specifies the product record containing the product ID 115b corresponding to the product ID 111d from the product record of the retailer X stored in the product information DB 115, and acquires the order destination ID 115c of the specified product record. Then, the order processing unit 103 sets the acquired order destination ID 115c to the order destination ID 112d. In addition, the order processing unit 103 sets the product ID 112e with the product ID 111d which is contained in the corresponding sales record. In addition, the order processing unit 103 sets the order quantity 112f with a total value of the sales quantity 111e contained in the corresponding sales record. In addition, the order processing unit 103 sets the order amount 112g with an amount based on the buying price of the product from the wholesaler Y of the order destination. In other words, the order processing unit 103 acquires the buying price contained in a unit price 115d of the product record of the retailer X which is specified as described above. Then, the order processing unit 103 sets the order amount 112g with a value obtained by multiplying the acquired buying price by the order quantity 112f.

Further, the order processing unit 103 may generate one corresponding order record for a plurality of sales records which are different in the date 111c but common in the product ID 111d. In this case, the order processing unit 103 sums up the sales quantities 111e of the plurality of sales records, and sets the total value to the order quantity 112f of the order record.

Further, the order processing unit 103 may transmit the order information containing at least a part of the generated order record to the retailer device 2 of the order source, the wholesaler device 3 of the order destination, and the like.

Then, the transaction support device 1 determines whether the inventory of the wholesaler Y of the order destination satisfies a predetermined condition (Step S120). Specifically, the order processing unit 103 performs the following processing for each order record of the retailer X which is generated in Step S110. The order processing unit 103 specifies the inventory record containing the product ID 116b corresponding to the product ID 112e of the order record from the inventory record which is stored in the inventory information DB 116 and associated to the company ID 116a corresponding to the order destination ID 112d of the order record, and acquires the inventory quantity 116d and the inventory threshold 116e of the specified inventory record. Then, a difference (the inventory quantity−the order quantity) between the acquired inventory quantity 116d and the order quantity 112f of the order record is calculated. In addition, the order processing unit 103 determines whether the calculated difference exceeds the acquired inventory threshold 116e.

The order processing unit 103 makes the process proceed to Step S130 with respect to the order record of the retailer X in a case where the difference between the inventory quantity and the order quantity is equal to or less than the inventory threshold (Step S120: N). The order processing unit 103 makes the process proceed to Step S160 with respect to the order record of the retailer X in case where the difference between the inventory quantity and the order quantity exceeds the inventory threshold (Step S120: Y). In other words, the processes of Steps S130 to S150 below are performed on a product of which the difference between the inventory quantity and the order quantity is equal to or less than the inventory threshold. Steps S160 to S170 below are performed on a product of which the difference between the inventory quantity and the order quantity is equal to or less than the inventory threshold and a product of which the difference between the inventory quantity and the order quantity exceeds the inventory threshold.

The transaction support device 1 generates the order information of the wholesaler Y (Step S130). Specifically, the order processing unit 103 performs the following processes for each order record of the retailer X of which the difference between the inventory quantity and the order quantity is determined to be equal to or less than the inventory threshold in Step S120. The order processing unit 103 specifies the company ID 112a (here, any one of the wholesalers Y₁ to Yₘ) corresponding to the order destination ID 112d of the order record of the retailer X, and stores the order record in the order information DB 112 in association with the subject company ID 112a. In addition, the order processing unit 103 sets the order ID 112b with an ID for uniquely specifying the generated order record. In addition, the order processing unit 103 sets the date 112c with a date when the order record is generated. In addition, the order processing unit 103 sets the order destination ID 112d with the company ID of the company (here, any one of the manufacturers Z₁ to Zₙ) of the order destination of the product indicated by the product ID 111d contained in the corresponding order record of the retailer X. In other words, the order processing unit 103 specifies the product record which contains the product ID 115b corresponding to the product ID 112e of the order record of the retailer X from the product record associated to the company ID 112a of the wholesaler Y which is specified as above and stored in the product information DB 115, and acquires the order destination ID 115c of the specified product record. Then, the order processing unit 103 sets the order destination ID 112d with the acquired order destination ID 115c. In addition, the order processing unit 103 sets the product ID 112e with the product ID 112e contained in the order record of the retailer X. In addition, the order processing unit 103 sets the order quantity 112f with the order quantity 112f contained in the order record of the retailer X. In addition, the order processing unit 103 sets the order amount 112g with an amount based on the buying price of the product obtained from the manufacturer Z of the order destination. In other words, the order processing unit 103 acquires the buying price contained in the unit price 115d of the product record of the wholesaler Y which is specified as above. Then, the order processing unit 103 sets the order amount 112g with a value obtained by multiplying the acquired buying price by the order quantity 112f.

Further, the order processing unit 103 may transmit the order information containing at least a part of the generated order record to the wholesaler device 3 of the order source and the manufacturer device 4 of the order destination.

Then, the transaction support device 1 generates the shipping information of the manufacturer Z (Step S140). Specifically, the order processing unit 103 performs the following processes on each order record of the wholesaler Y which are generated in Step S130. The order processing unit 103 specifies the company ID 113a (here, any one of the manufacturers Z₁ to Zₙ) corresponding to the order destination ID 112d of the order record of the wholesaler Y, and stores the shipping record in the shipping information DB 113 in association with the subject company ID 113a. In addition, the order processing unit 103 sets the shipping ID 113b with an ID for uniquely specifying the generated shipping record. In addition, the order processing unit 103 sets the date 113c with a date when the shipping record is generated. In addition, the order processing unit 103 sets the receipt destination ID 113d with the company ID 112a (here, any one of the wholesalers Y₁ to Yₘ) of the corresponding order record. In addition, the order processing unit 103 sets the product ID 113e with the product ID 112e contained in the corresponding order record. In addition, the order processing unit 103 sets the shipping quantity 113f with the order quantity 112f contained in the corresponding order record. In addition, the order processing unit 103 sets the shipping amount 113g with the order amount 112g contained in the corresponding order record. In addition, the order processing unit 103 sets the inspection state 113h with “uninspected product”.

Then, the transaction support device 1 sends the shipping instruction to the manufacturer Z (Step S150). Specifically, the order processing unit 103 performs the following processes on each shipping record of the manufacturer Z which is generated in Step S140. The order processing unit 103 sends the shipping instruction containing at least a part of the content of the subject shipping record to the manufacturer device 4 of the manufacturer Z indicated by the company ID 113a of the shipping record through the communication unit 120. Then, the order processing unit 103 makes the process proceed to Step S160.

Further, the order processing unit 103 may transmit the shipping information containing at least a part of the contents of the generated shipping record to the wholesaler device 3 of a shipping destination or the like.

The transaction support device 1 generates the shipping information of the wholesaler Y (Step S160). Specifically, the order processing unit 103 performs the following processes on each order record of the retailer X which is generated in Step S110. The order processing unit 103 specifies the company ID 113a (here, any one of the wholesalers Y₁ to Yₘ) corresponding to the order destination ID 112d of the order record of the retailer X, and stores the shipping record in the shipping information DB 113 in association with the subject company ID 113a. In addition, the order processing unit 103 sets the shipping ID 113b with an ID for uniquely specifying the generated shipping record. In addition, the order processing unit 103 sets the date 113c with a date when the shipping record is generated. In addition, the order processing unit 103 sets the receipt destination ID 113d with the company ID 112a (here, the retailer X) of the corresponding order record. In addition, the order processing unit 103 sets the product ID 113e with the product ID 112e contained in the corresponding order record. In addition, the order processing unit 103 sets the shipping quantity 113f with the order quantity 112f contained in the corresponding order record. In addition, the order processing unit 103 sets the shipping amount 113g with the order amount 112g contained in the corresponding order record. In addition, the order processing unit 103 sets the inspection state 113h with “uninspected product”.

Then, the transaction support device 1 sends the shipping instruction to the wholesaler Y (Step S170). Specifically, the order processing unit 103 performs the following processes for each shipping record of the wholesaler Y which is generated in Step S160. The order processing unit 103 sends the shipping instruction containing at least a part of the contents of the subject shipping record to the wholesaler device 3 of the wholesaler Y indicated by the company ID 113a of the shipping record through the communication unit 120. Then, the order processing unit 103 ends this flow.

Further, the order processing unit 103 may transmit the shipping information containing at least a part of the contents of the generated shipping record to the retailer device 2 of the shipping destination or the like.

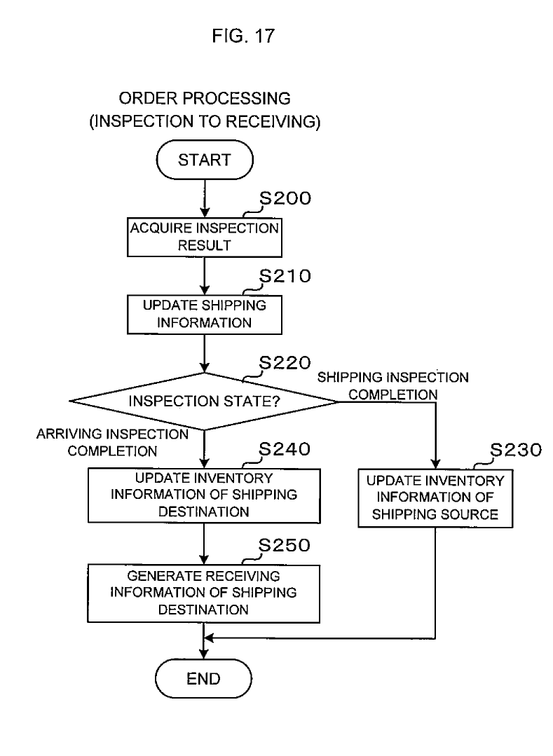

FIG. 17 is a flowchart illustrating an example of an order processing (inspection to receiving). The flow starts in a case where an inspection result of a target product of the shipping instruction is input. As an example of a method of inputting the inspection result, while not particularly limited, the transaction support device 1 receives an input from the retailer device 2, the wholesaler device 3, the manufacturer device 4, and the like through the network 7.

When this flow starts, the transaction support device 1 acquires the inspection result from any one of the retailer X, the wholesalers Y₁ to Yₘ, and the manufacturers Z₁ to Zₙ (Step S200). Specifically, the order processing unit 103 communicates with the retailer device 2, the wholesaler devices 3₁ to 3ₘ, the manufacturer device 4₁ to 4ₙ, and the like through the communication unit 120, and receives the shipping ID and the inspection state (“shipping inspection completion” or “arriving inspection completion”) as the input.

Then, the transaction support device 1 updates the shipping information (Step S210). Specifically, the order processing unit 103 specifies the shipping record containing the shipping ID 113b corresponding to the shipping ID received in Step S200 from the shipping information DB 113. In addition, the order processing unit 103 sets the inspection state 113h of the specified shipping record with the received inspection state.

Then, the transaction support device 1 determines the inspection state of the shipping information (Step S220). Specifically, the order processing unit 103 determines whether the inspection state 113h of the shipping record updated in Step S210 is “shipping inspection completion” or “arriving inspection completion”.

In a case where the inspection state of the shipping record is “shipping inspection completion” (Step S220: shipping inspection completion), the transaction support device 1 updates the inventory information of the shipping source (Step S230). Specifically, the order processing unit 103 specifies the inventory record containing the product ID 116b corresponding to the product ID 113e of the subject shipping record in the inventory record associated to the company ID 116a corresponding to the company ID 113a (the shipping source) of the shipping record updated in Step S210. Then, the order processing unit 103 subtracts the shipping quantity 113f of the subject shipping record from the inventory quantity 116d of the specified inventory record. In addition, the order processing unit 103 sets the updated date 116f of the specified inventory record with a date where the inventory record is updated. Then, the order processing unit 103 ends this flow.

On the other hand, in a case where the inspection state of the shipping record is “arriving inspection completion” (Step S220: arriving inspection completion), the transaction support device 1 updates the inventory information of the shipping destination (Step S240). Specifically, the order processing unit 103 specifies the inventory record containing the product ID 116b corresponding to the product ID 113e of the subject shipping record in the inventory record associated to the company ID 116a corresponding to the receipt destination ID 113d (the shipping destination) of the shipping record updated in Step S210. Then, the order processing unit 103 adds the shipping quantity 113f of the shipping record to the inventory quantity 116d of the specified inventory record. In addition, the order processing unit 103 sets the updated date 116f of the specified inventory record with a date when the inventory record is updated.

Then, the transaction support device 1 generates the receiving information of the shipping destination (Step S250). Specifically, the order processing unit 103 specifies the company ID 114a corresponding to the receipt destination ID 113d (the shipping destination) of the shipping record updated in Step S210, and stores the receipt record in the receiving information DB 114 in association with the subject company 114a. In addition, the order processing unit 103 sets the receipt ID 114b with an ID for uniquely specifying the generated receipt record. In addition, the order processing unit 103 sets the date 114c with a date when the receipt record is generated. In addition, the order processing unit 103 sets the shipping source ID 114d with the company ID 113a (the shipping source) of the shipping record updated in Step S210. In addition, the order processing unit 103 sets the product ID 114e with the product ID 113e of the subject shipping record. In addition, the order processing unit 103 sets the receipt quantity 114f with the shipping quantity 113f of the subject shipping record. In addition, the order processing unit 103 sets the receipt amount 114g with the shipping amount 113g of the subject shipping record. Then, the order processing unit 103 ends this flow.

Further, the order processing unit 103 may transmit the receiving information containing at least a part of the generated receipt record to the retailer device 2 of the receipt destination, the wholesaler device 3 of the receipt destination, the wholesaler device 3 of the shipping source, and the manufacturer device 4 of the shipping source.

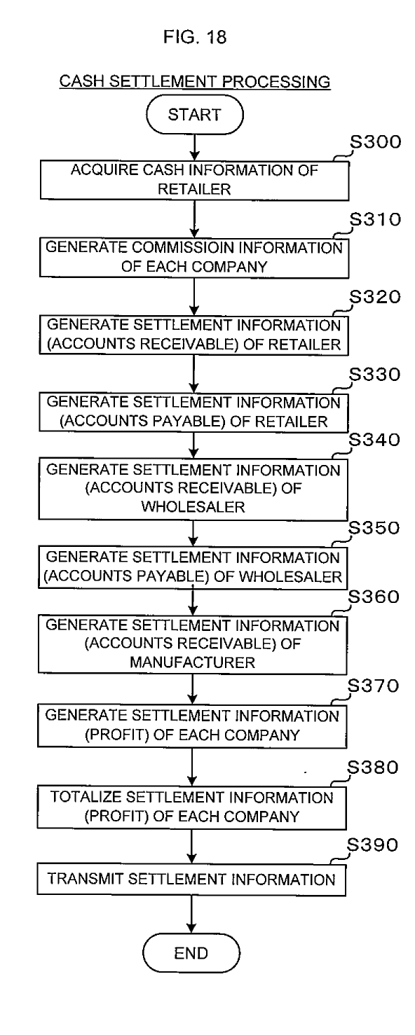

FIG. 18 is a flowchart illustrating an example of a cash settlement processing. This flow, for example, starts in a predetermined period such as a day, a week, or a month. The predetermined period, for example, may be determined between the retailer X, the cash recovery company Q, and the transaction support company P.

When this flow starts, the transaction support device 1 acquires the cash information of the retailer X (Step S300). Specifically, the cash information acquisition unit 102 makes a communication with the cash recovery company device 5 through the communication unit 120, and acquires the cash information of the retailer X of the predetermined period. In addition, the cash information acquisition unit 102 generates the cash record for each date based on the acquired cash information of the retailer X, and stores the generated cash record in the cash information DB 117 in association with the company ID 117a of the retailer X. The cash information acquisition unit 102 sets the date 117b, the payment amount 117c, and the deposit amount 117d with a date contained in the acquired cash information of the retailer X, the payment amount, and the deposit amount, respectively.

Then, the transaction support device 1 generates the commission information of the transaction support company P, the cash recovery company Q, and the finance company R (Step S310). Specifically, the settlement processing unit 104 calculates the commission of each company of the predetermined period based on a predetermined calculation formula of the commission.

The commission of the transaction support company P, for example, may be set to a value obtained by multiplying a predetermined coefficient by a total number of the order record of the retailer X of the subject date and the order records of the wholesalers Y₁ to Yₘ of the subject date for each date in the predetermined period. In other words, the commission may be set to an amount according to the number of handling order records relating to the retailer X for each date in the predetermined period of a settlement target.

The commission of the cash recovery company Q, for example, may be set to a value obtained by multiplying a predetermined coefficient by the payment amount (which can be acquired from the cash information DB 117) of the retailer X of the subject date for each date in the predetermined period of the settlement target. In other words, the commission may be set to an amount according to the handling amount relating to the retailer X for each date in the predetermined period of the settlement target.

The commission of the finance company R, for example, may be set to a value obtained by multiplying a predetermined coefficient by the cash sales (the difference between the payment amount and the deposit amount of the cash information DB 117) of the retailer X of the subject date for each date in the predetermined period of the settlement target. In other words, the commission may be set to an amount according to the handling amount relating to the retailer X for each date in the predetermined period of the settlement target.

Of course, the method of calculating the commission of each company is not limited to the above example. In addition, the commission of each company may be set to a fixed amount, such as for each day, week, or month.

The settlement processing unit 104 adds the commission record of the company ID 119a of the transaction support company P for each date in the predetermined period, and sets the date 119b and the commission 119c of each commission record with the corresponding date and the calculated commission of the transaction support company P as above. In addition, the settlement processing unit 104 adds the commission record of the company ID 119a of the cash recovery company Q for each date in the predetermined period, and sets the date 119b and the commission 119c of each commission record with the corresponding date and the calculated commission of the cash recovery company Q as above. In addition, the settlement processing unit 104 adds the commission record of the company ID 119a of the finance company R for each date in the predetermined period, and sets the date 119b and the commission 119c of each commission record with the corresponding date and the calculated commission of the finance company R as above.

Then, the transaction support device 1 generates the settlement information (the accounts receivable) of the retailer X (Step S320). Specifically, the settlement processing unit 104 generates the settlement record corresponding to each date in the predetermined period, and stores the generated settlement record in the settlement information DB 118 in association with the company ID 118a of the retailer X. In addition, the settlement processing unit 104 performs the following processes on each generated settlement record of the retailer X. The settlement processing unit 104 sets the date 118b with the corresponding date. In addition, the settlement processing unit 104 specifies the cash record of the retailer X containing the date 117b corresponding to the date 118b, calculates a difference (payment amount−deposit amount) between the payment amount 117c and the deposit amount 117d of the subject cash record, and sets the accounts receivable 118c with the calculated difference.

Then, the transaction support device 1 generates the settlement information (the accounts payable) of the retailer X (Step S330). Specifically, the settlement processing unit 104 performs the following processes on each settlement record of the retailer X corresponding to each date in the predetermined period generated in Step S320. The settlement processing unit 104 specifies the receipt record containing the date 114c corresponding to the date 118b of the settlement record in the receipt record of the company ID 114a of the retailer X. Then, the settlement processing unit 104 sums up the receipt amount 114g of the specified each receipt record, and sets the accounts payable 118d of the settlement record with the total value.

Then, the transaction support device 1 generates the settlement information (the accounts receivable) of the wholesaler Y (Step S340). Specifically, the settlement processing unit 104 generates the settlement record corresponding to each date in the predetermined period for each of the wholesalers Y₁ to Yₘ, and stores the generated settlement record in the settlement information DB 118 in association with the company ID 118a of each of the wholesalers Y₁ to Yₘ. In addition, the settlement processing unit 104 performs the following processes for the generated settlement record for each of the wholesalers Y₁ to Yₘ. The settlement processing unit 104 sets the date 118b with the corresponding date. In addition, the settlement processing unit 104 specifies the shipping record in which the date 113c corresponding to the date 118b of the settlement record is contained and the inspection state 113h is “arriving inspection completion” in the shipping record associated to the company ID 113a of the wholesaler Y. Then, the shipping amount 113g of the each specified shipping record is summed up, and the subject total value is set to the accounts receivable 118c of the settlement record.

Then, the transaction support device 1 generates the settlement information (the accounts payable) of the wholesaler Y (Step S350). Specifically, the settlement processing unit 104 performs the following processes for each settlement record corresponding to each date in the predetermined period generated in Step S340 on each of the wholesalers Y₁ to Yₘ. The settlement processing unit 104 specifies the receipt record containing the date 114c corresponding to the date 118b of the settlement record in the receipt record associated to the company ID 114a of the wholesaler Y. Then, the settlement processing unit 104 sums up the receipt amount 114g of each specified receipt record, and sets the subject total value to the accounts payable 118d of the settlement record.

Then, the transaction support device 1 generates the settlement information (the accounts receivable) of the manufacturer Z (Step S360). Specifically, the settlement processing unit 104 generates the settlement record corresponding to each date in the predetermined period for each of the manufacturers Z₁ to Zₙ, and stores the generated settlement record in the settlement information DB 118 in association with the company ID 118a of each of the manufacturers Z₁ to Zₙ. In addition, the settlement processing unit 104 performs the following processes on the generated settlement record for each of the manufacturers Z₁ to Zₙ. The settlement processing unit 104 sets the date 118b with the corresponding date. In addition, the settlement processing unit 104 specifies the shipping record in which the date 113c corresponding to the date 118b of the settlement record is contained and the inspection state 113h is “arriving inspection completion” in the shipping record associated to the company ID 113a of the manufacturer Z. Then, the shipping amount 113g of each specified shipping record is summed up, and the subject total value is set to the accounts receivable 118c of the settlement record. Further, the accounts payable 118d of the settlement record of the manufacturer Z is set to 0.

Then, the transaction support device 1 generates the settlement information (profits) of the retailer X, the wholesaler Y, and the manufacturer Z (Step S370). Specifically, the settlement processing unit 104 performs the following processes for each settlement record of the retailer X corresponding to each date in the predetermined period. The settlement processing unit 104 acquires the commission 119c of the commission record of each company (the transaction support company P, the cash recovery company Q, or the finance company R) in which the date 119b corresponding to the date 118b of the subject settlement record is contained, and calculates a total value. In addition, the settlement processing unit 104 calculates a difference between the accounts receivable 118c and the accounts payable 118d of the subject settlement record and the calculated total value of the commissions (accounts receivable−accounts payable−total commission), and sets the difference to the profit 118e of the subject settlement record.

In addition, the settlement processing unit 104 performs the following processes for each settlement record corresponding to each date in the predetermined period on each of the wholesalers Y₁ to Yₘ. The settlement processing unit 104 calculates a difference between the accounts receivable 118c and the accounts payable 118d of the settlement record (accounts receivable−accounts payable), and sets the difference to the profit 118e of the subject settlement record.

In addition, the settlement processing unit 104 performs the following processes for each settlement record corresponding to each date in the predetermined period on each of the manufacturers Z₁ to Z. The settlement processing unit 104 calculates a difference between the accounts receivable 118c and the accounts payable 118d of the settlement record (accounts receivable−accounts payable), and sets the difference to the profit 118e of the subject settlement record.

Then, the transaction support device 1 totalizes the settlement information of each company (Step S380). Specifically, the settlement processing unit 104 sums up the profit 118e of the settlement record of the retailer X corresponding to each date in the predetermined period for the retailer X. In addition, the settlement processing unit 104 sums up the profit 118e of the settlement record corresponding to each date in the predetermined period for each of the wholesalers Y₁ to Yₘ. In addition, the settlement processing unit 104 sums up the profit 118e of the settlement record corresponding to each date in the predetermined period for each of the manufacturers Z₁ to Zₙ. Therefore, the profits of the predetermined period of the retailer X, each of the wholesalers Y₁ to Yₘ, and each of the manufacturers Z₁ to Zₙ can be calculated.

In addition, the settlement processing unit 104 sums up the commission 119c of the commission record corresponding to each date in the predetermined period for the transaction support company P. In addition, the settlement processing unit 104 sums up the commission 119c of the commission record corresponding to each date in the predetermined period for the cash recovery company Q. In addition, the settlement processing unit 104 sums up the commission 119c of the commission record corresponding to each date in the predetermined period for the finance company R. Therefore, the commissions (profits) of the predetermined period of the transaction support company P, the cash recovery company Q, and the finance company R can be calculated.

Then, the transaction support device 1 transmits the settlement information (Step S390). Specifically, the settlement information output unit 105 sends the settlement information containing the profits of the predetermined period of the retailer X, each of the wholesalers Y₁ to Yₘ, and each of the manufacturers Z₁ to Zₙ calculated in Step S380 and the commissions (profits) of the predetermined period of the transaction support company P, the cash recovery company Q, and the finance company R calculated in Step S380 to the finance company device 6 through the communication unit 120. Then, the settlement information output unit 105 ends this flow.

Further, the finance company device 6 receives the settlement information from the transaction support device 1 (this function is also referred to as the “settlement information receiving unit”), shares the profits to the retailer X, the wholesaler Y, the manufacturer Z, the transaction support company P, the cash recovery company Q, and the finance company R from the total sum of the cash sales of the predetermined period of the retailer X deposited in a predetermined account based on the received settlement information, and deposits the profit of each company in the account of each company (this function is also referred to as a “profit sharing unit”). Therefore, the profit of each company (the retailer X, the wholesaler Y, the manufacturer Z, the transaction support company P, the cash recovery company Q, and the finance company R) is shared from the cash sales of the retailer X.

Further, the settlement information output unit 105 may transmit the settlement information containing at least a part of the contents of the settlement record generated for each company to the device of each company. In addition, the commission information containing at least a part of the contents of the commission record generated for each company may be transmitted to the device of each company.

A unit of processing in the flow of FIGS. 16 to 18 is divided according to the contents of a main processing in order to help with understanding of the processing of the transaction support device 1. The present invention is not limited to a method of dividing the unit of processing or the name thereof. The processing of the transaction support device 1 may be divided into more units of processing according to the contents of the processing. In addition, one unit of processing may be divided to contain more processings. In addition, the procedure of the processings of the flow is also not limited to the example illustrated in the drawings.

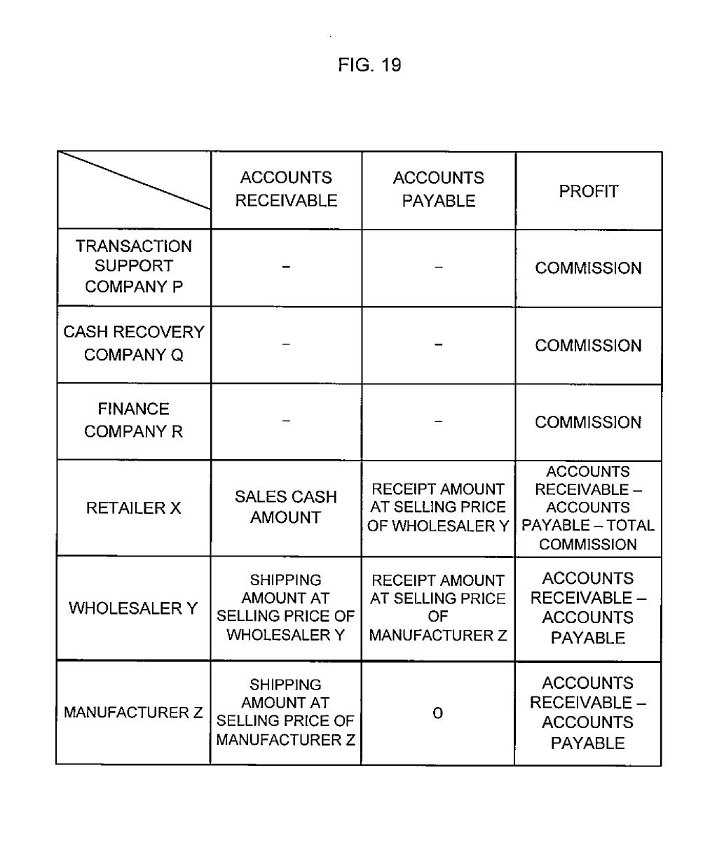

Further, a relation between the accounts receivable, the accounts payable, and the profit of each company may be collectively expressed as shown in FIG. 19 (a diagram for describing the relation between the accounts receivable, the accounts payable, and the profit). In other words, the profit of the transaction support company P is the commission of the transaction support company P. In addition, the profit of the cash recovery company Q is the commission of the cash recovery company Q. In addition, the profit of the finance company R is the commission of the finance company R. In addition, the profit of the retailer X is a difference between the sales cash of the retailer X, the accounts payable of the receiving product at the selling price of the wholesaler Y (the buying price from the wholesaler Y), and the total commission. In addition, the profit of the wholesaler Y is a difference between the accounts receivable of the shipping product at the selling price of the wholesaler Y and the accounts payable of the receiving product at the selling price of the manufacturer Z (the buying price from the manufacturer Z). In addition, the profit of the manufacturer Z is a difference between the accounts receivable of the shipping product at the selling price of the manufacturer Z and the accounts payable of the manufacturer Z (handled as 0).

Hitherto, an embodiment of the present invention has been described. According to this embodiment, it is possible to uniformly support business processing related to commercial transactions between a plurality of business entities such as the retailers, the wholesalers, and the manufacturers.

For example, according to this embodiment, the business processing such as the order, the inventory, and the settlement with respect to the commercial transaction between the plurality of business entities is uniformly controlled by the transaction support device. Since the order processing of the product is performed by the transaction support device, it is possible to reduce the business processing of each business entity regarding the order processing. In addition, since the order processing of the product starts automatically based on the sales information, it is possible to shorten a lead time until the product is delivered. In addition, since the inventory management is performed by the transaction support device, it is possible to reduce the business processing of each business entity regarding the inventory. In addition, since the balancing out between the accounts payable and the accounts receivable, the decision on the sharing of the profit from the cash sales, and the like are performed by the transaction support device, it is possible to reduce the business processing of each business entity regarding the settlement processing. In addition, since the profit of each business entity from the cash sales is shared through the cash recovery company and a financial institution, the work load such as invoicing and payment between the business entities is significantly reduced and the income of cash is reliably secured.

Further, an embodiment of the present invention is intended to exemplarily show the spirit and the scope of the present invention, but not to impose a limit. Many substitutions, changes, and modifications can be made by a person skilled in the art, and all of them fall within the spirit and the scope of the present invention.

For example, the relation between the support-target business entities is not limited to the relation between three business entities: the retailer, the wholesaler, and the manufacturer. For example, the business entities such as a company of the order destination may be expanded from the manufacturer, or may be reduced. In addition, for example, the support-target business entities are not limited to the retailer, the wholesaler, and the manufacturer as long as the commercial transaction is performed between a plurality of business entities. In addition, even in a case where there is a plurality of retailers, the present invention can be applied.

In addition, in the above embodiment, the transaction support device 1 generates the commission information for all of the companies of the transaction support company P, the cash recovery company Q, and the finance company R, but the commission information may be generated for a part of the companies.

In addition, for example, it may be considered that the profit of the predetermined period of the wholesaler Y is a negative value (the accounts payable exceeds the accounts receivable). In this case, the finance company device 6 debits an amount corresponding to the profit from an account of the wholesaler Y of which the profit of the predetermined period is a negative value based on the settlement information received from the transaction support device 1. Then, the profit is shared to the retailer X, the wholesaler Y (the wholesaler Y of which the profit is a positive value), the manufacturer Z, the transaction support company P, the cash recovery company Q, and the finance company R from a total amount of the debited amounts and the cash sales of the predetermined period of the retailer X which is deposited in the predetermined account.

### REFERENCE SIGNS LIST

1: Transaction support device
2: Retailer device
3: Wholesaler device
4: Manufacturer device
5: Cash recovery company device
6: Finance company device
7: Network
10: Transaction system
P: Transaction support company
Q: Cash recovery company
R: Finance company
X: Retailer
Y: Wholesaler
Z: Manufacturer
40: Computer
41: CPU
42: Memory
43: External storage device
44: Communication I/F
45: Input device
46: Output device
47: Media I/F
100: Control unit
101: Sales information acquisition unit
102: Cash information acquisition unit
103: Order processing unit
104: Settlement processing unit
105: Settlement information output unit
110: Storage unit
111: Sales information DB
111a: Company ID
111b: Sales ID
111c: Date
111d: Product ID
111e: Sales quantity
111f: Sales amount
112: Order information DB
112a: Company ID
112b: Order ID
112c: Date
112d: Order destination ID
112e: Product ID
112f: Order quantity
112g: Order amount
113: Shipping information DB
113a: Company ID
113b: Shipping ID
113c: Date
113d: Receipt destination ID
113e: Product ID
113f: Shipping quantity
113g: Shipping amount
113h: Inspection state
114: Receiving information DB
114a: Company ID
114b: Receipt ID
114c: Date
114d: Shipping source ID
114e: Product ID
114f: Receipt quantity
114g: Receipt amount
115: Product information DB
115a: Company ID
115b: Product ID
115c: Order destination ID
115d: Unit price
116: Inventory information DB
116a: Company ID
116b: Product ID
116c: Unit price
116d: Inventory quantity
116e: Inventory threshold
116f: Updated date
117: Cash information DB
117a: Company ID
117b: Date
117c: Payment amount
117d: Deposit amount
118: Settlement information DB
118a: Company ID
118b: Date
118c: Accounts receivable
118d: Accounts payable
118e: Profit
119: Commission information DB
119a: Company ID
119b: Date
119c: Commission
120: Communication unit

1. A transaction support device that supports a transaction between a plurality of business entities in a business relation through a network, comprising:
a sales information acquisition unit configured to acquire sales information of a first business entity through the network;
a transaction processing unit configured to perform generating of order information of the first business entity based on the acquired sales information, generating of shipping information of a second business entity based on the order information, and generating of receiving information of the first business entity based on the shipping information with respect to a transaction between the first business entity and the second business entity which is an order destination of the first business entity;
a cash information acquisition unit configured to acquire cash information indicating a cash sales recovered from the first business entity by a cash recovery company through the network from a device of the cash recovery company;
a settlement processing unit configured to perform a first settlement processing in which account-receivable information indicating accounts receivable of the first business entity is generated based on the acquired cash information, account-payable information indicating accounts payable of the first business entity is generated based on the receiving information of the first business entity, and profit information indicating a profit of the first business entity is generated based on the account-receivable information and the account-payable information of the first business entity, and a second settlement processing in which account-receivable information indicating accounts receivable of the second business entity is generated based on the shipping information of the second business entity, and profit information indicating a profit of the second business entity is generated based on the account-receivable information of the second business entity; and
a settlement information output unit configured to output settlement information containing the generated profit information of the first business entity and the second business entity to a device of a finance company through the network, the finance company acquiring the cash sales recovered from the first business entity from the cash recovery company.

2. The transaction support device according to claim 1,
wherein the transaction processing unit performs generating of order information of the second business entity based on the order information of the first business entity, generating of shipping information of a third business entity based on the order information, and generating of receiving information of the second business entity based on the shipping information with respect to a transaction between the second business entity and the third business entity which is an order destination of the second business entity,
the settlement processing unit generates account-payable information indicating accounts payable of the second business entity based on the receiving information of the second business entity, generates the profit information of the second business entity based on the account-receivable information and the account-payable information of the second business entity in the second settlement processing, and performs a third settlement processing in which account-receivable information indicating accounts receivable of the third business entity is generated based on the shipping information of the third business entity, and profit information indicating a profit of the third business entity is generated based on the account-receivable information of the third business entity, and
the settlement information output unit outputs the settlement information containing the generated profit information of the first business entity, the second business entity, and the third business entity to the device of the finance company.

3. The transaction support device according to claim 2,
wherein the settlement processing unit performs generating of commission information indicating commissions of the cash recovery company, the finance company, and a transaction support company which manages the transaction support device based on a predetermined calculation formula or a predetermined value, and
the settlement information output unit outputs the settlement information containing the generated profit information of each business entity and the generated commission information of each company to the device of the finance company.

4. The transaction support device according to claim 3,
wherein the transaction processing unit acquires inventory information of the second business entity, determines whether the inventory information satisfies a predetermined condition on the order information based on the order information of the first business entity and the inventory information of the second business entity, and performs a transaction between the second business entity and the third business entity in a case where the predetermined condition is not satisfied.

5. A program for causing a computer as a transaction support device that supports a transaction between a plurality of business entities in a business relation through a network, wherein the program causes the computer to function as:
a sales information acquisition unit configured to acquire sales information of a first business entity through the network;
a transaction processing unit configured to perform generating of order information of the first business entity based on the acquired sales information, generating of shipping information of a second business entity based on the order information, and generating of receiving information of the first business entity based on the shipping information with respect to a transaction between the first business entity and the second business entity which is an order destination of the first business entity;
a cash information acquisition unit configured to acquire cash information indicating a cash sales recovered from the first business entity by a cash recovery company through the network from a device of the cash recovery company;
a settlement processing unit configured to perform a first settlement processing in which account-receivable information indicating accounts receivable of the first business entity is generated based on the acquired cash information, account-payable information indicating accounts payable of the first business entity is generated based on the receiving information of the first business entity, and profit information indicating a profit of the first business entity is generated based on the account-receivable information and the account-payable information of the first business entity, and a second settlement processing in which account-receivable information indicating accounts receivable of the second business entity is generated based on the shipping information of the second business entity, and profit information indicating a profit of the second business entity is generated based on the account-receivable information of the second business entity; and
a settlement information output unit configured to output settlement information containing the generated profit information of the first business entity and the second business entity to a device of a finance company through the network, the finance company acquiring the cash sales recovered from the first business entity from the cash recovery company.

6. A transaction support method in a transaction support device that supports a transaction between a plurality of business entities in a business relation through a network, comprising:
acquiring sales information of a first business entity through the network;
generating order information of the first business entity based on the acquired sales information, generating shipping information of a second business entity based on the order information, and generating receiving information of the first business entity based on the shipping information with respect to a transaction between the first business entity and the second business entity which is an order destination of the first business entity;
acquiring cash information indicating a cash sales recovered from the first business entity by a cash recovery company through the network from a device of the cash recovery company;
performing a first settlement processing in which account-receivable information indicating accounts receivable of the first business entity is generated based on the acquired cash information, account-payable information indicating accounts payable of the first business entity is generated based on the receiving information of the first business entity, and profit information indicating a profit of the first business entity is generated based on the account-receivable information and the account-payable information of the first business entity, and a second settlement processing in which account-receivable information indicating accounts receivable of the second business entity is generated based on the shipping information of the second business entity, and profit information indicating a profit of the second business entity is generated based on the account-receivable information of the second business entity; and
outputting settlement information containing the generated profit information of the first business entity and the second business entity to a device of a finance company through the network, the finance company acquiring the cash sales recovered from the first business entity from the cash recovery company.

7. A transaction support system comprising:
a transaction support device configured to support a transaction of a plurality of business entities in a business relation through a network; and
a device of a finance company which is connected to the transaction support device through the network,
wherein the transaction support device includes
a sales information acquisition unit configured to acquire sales information of a first business entity through the network,
a transaction processing unit configured to perform generating of order information of the first business entity based on the acquired sales information, generating of shipping information of a second business entity based on the order information, and generating of receiving information of the first business entity based on the shipping information with respect to a transaction between the first business entity and the second business entity which is an order destination of the first business entity,
a cash information acquisition unit configured to acquire cash information indicating a cash sales recovered from the first business entity by a cash recovery company through the network from a device of the cash recovery company,
a settlement processing unit configured to perform a first settlement processing in which account-receivable information indicating accounts receivable of the first business entity is generated based on the acquired cash information, account-payable information indicating accounts payable of the first business entity is generated based on the receiving information of the first business entity, and profit information indicating a profit of the first business entity is generated based on the account-receivable information and the account-payable information of the first business entity, and a second settlement processing in which account-receivable information indicating accounts receivable of the second business entity is generated based on the shipping information of the second business entity, and profit information indicating a profit of the second business entity is generated based on the account-receivable information of the second business entity, and
a settlement information output unit configured to output settlement information containing the generated profit information of the first business entity and the second business entity to the device of the finance company through the network, and
wherein the device of the finance company includes
a settlement information receiving unit configured to receive the settlement information from the transaction support device through the network, and
a profit sharing unit configured to deposit a profit of the first business entity and a profit of the second business entity in an account of each business entity, based on the received settlement information, from the cash sales which is recovered by the cash recovery company from the first business entity and acquired by the finance company from the cash recovery company.

8. A transaction support method in a transaction support system that includes a transaction support device configured to support a transaction of a plurality of business entities in a business relation through a network, and a device of a finance company which is connected to the transaction support device through the network, comprising:
acquiring, by the transaction support device, sales information of a first business entity through the network;
generating, by the transaction support device, order information of the first business entity based on the acquired sales information, generating shipping information of a second business entity based on the order information, and generating receiving information of the first business entity based on the shipping information with respect to a transaction between the first business entity and the second business entity which is an order destination of the first business entity;
acquiring, by the transaction support device, cash information indicating a cash sales recovered from the first business entity by a cash recovery company through the network from a device of the cash recovery company;
performing, by the transaction support device, a first settlement processing in which account-receivable information indicating accounts receivable of the first business entity is generated based on the acquired cash information, account-payable information indicating accounts payable of the first business entity is generated based on the receiving information of the first business entity, and profit information indicating a profit of the first business entity is generated based on the account-receivable information and the account-payable information of the first business entity, and a second settlement processing in which account-receivable information indicating accounts receivable of the second business entity is generated based on the shipping information of the second business entity, and profit information indicating a profit of the second business entity is generated based on the account-receivable information of the second business entity;
outputting, by the transaction support device, settlement information containing the generated profit information of the first business entity and the second business entity to the device of the finance company through the network;
receiving, by the device of the finance company, the settlement information from the transaction support device through the network; and
depositing, by the device of the finance company, a profit of the first business entity and a profit of the second business entity in an account of each business entity, based on the received settlement information, from the cash sales which is recovered by the cash recovery company from the first business entity and acquired by the finance company from the cash recovery company.
